(19) United States
(12) Patent Application Publication
(10) Pub. No.: US 2026/0368237 A1
(43) Pub. Date: Nov. 19, 2026

(54) MULTI-AGENT FRAMEWORK FOR DOMAIN-SPECIFIC DATA GENERATION

(71) Applicant: International Business Machines Corporation, Armonk, NY (US)

(72) Inventors: Dhavalkumar C. PATEL, White Plains, NY (US); Christodoulos CONSTANTINIDES, New York, NY (US); Vivek SHARMA, Bangalore (IN); Shuxin LIN, White Plains, NY (US); Nianjun ZHOU, Chappaqua, NY (US); Bharathi CHAUDHURY, Bangalore (IN)

(21) Appl. No.: 19/209,977

(22) Filed: May 16, 2025

(51) Int. Cl. G06F 16/36; G06F 16/3329

(52) U.S. Cl. CPC G06F 16/367; G06F 16/3329

(57) ABSTRACT

A multi-agent framework for domain-specific data generation receives input data indicative of a domain context. A set of artificial intelligence (AI) agent personas is determined based on the domain context, each associated with a predefined role. The multi-agent framework is initialized with AI agents corresponding to the personas. A first set of domain-specific questions is generated based on the input data. Each question is assigned to at least one AI agent for processing. The AI agents collaboratively generate a second set of questions based on refinement of the first set and interactions among the agents. A set of answers corresponding to the second set of questions is generated based on domain-specific knowledge. Output data comprising at least one of the first set of questions, second set of questions, or set of answers is provided for use by a downstream application.

### BACKGROUND

The present invention relates to artificial intelligence, and for example, relates to a multi-agent framework for domain-specific data generation.

### BRIEF DESCRIPTION OF THE DRAWINGS

FIG. 1 is a block diagram of an example computing environment described herein.

FIG. 2A is a diagram showing an example methodology associated with implementing a multi-agent framework for domain-specific data generation.

FIG. 2B is a diagram showing an example implementation associated with a multi-agent framework for domain-specific data generation.

FIG. 2C is a diagram showing an example associated with domain-specific data generation.

FIG. 2D is a diagram showing another example associated with domain-specific data generation.

FIG. 3 is a diagram showing another example associated with domain-specific data generation.

FIG. 4A is a data flow diagram showing an example associated with implementing a multi-agent framework for domain-specific data generation.

FIG. 4B is a conceptual diagram showing an example associated with domain-specific question refinement.

FIG. 4C is a data flow diagram showing an example associated with domain-specific question refinement.

FIG. 5 is a diagram of an example computing environment in which systems and/or methods described herein may be implemented.

FIG. 6 is a diagram of example components of one or more devices of FIG. 1.

FIG. 7 is a flowchart of an example technique associated with domain-specific data generation described herein.

FIG. 8 is a flowchart of another example technique associated with domain-specific data generation described herein.

### DETAILED DESCRIPTION

The following detailed description of example implementations refers to the accompanying drawings. The same reference numbers in different drawings may identify the same or similar elements.

In the rapidly evolving landscape of industrial asset management and predictive maintenance, organizations face challenges in efficiently acquiring and leveraging domain-specific knowledge for artificial intelligence (AI) model development. The proliferation of diverse industrial assets, encompassing over 800 asset classes and 54,000 potential failure modes, has created a complex ecosystem that demands deep domain expertise to accurately interpret and model. Traditional approaches to knowledge acquisition often rely on time-consuming, manual collaboration between data scientists and subject matter experts (SMEs), leading to bottlenecks in AI implementation and potential gaps in insights.

Current AI tools and frameworks primarily focus on model building and testing, leaving a gap in the foundational domain understanding required for effective industrial AI applications. This technological shortfall results in data scientists spending excessive time framing and refining questions for SMEs, delaying the development of models for tasks such as predictive maintenance, anomaly detection, and reliability analysis. The manual process of question generation is prone to errors, often producing redundant or low-quality queries that limit the scope and relevance of acquired insights. Furthermore, the lack of automated, context-aware question generation capabilities hinders the scalability of domain knowledge acquisition across diverse industrial sectors.

The existing technological landscape lacks efficient mechanisms for simulating real-world collaborative interactions between data scientists and SMEs in a scalable, automated manner. This deficiency impedes the rapid iteration and refinement of domain-specific questions, resulting in suboptimal knowledge transfer and potentially compromising the quality of AI models. Additionally, current systems struggle to maintain linguistic diversity and technical depth in generated questions, often failing to capture the nuanced complexities of industrial operations and failure modes. The absence of sophisticated, multi-agent frameworks capable of dynamically routing questions to appropriate expert personas further exacerbates the challenge of efficiently extracting and synthesizing domain-specific knowledge.

These technological limitations not only impact the speed and accuracy of AI model development but also pose challenges in scaling industrial AI adoption across organizations. The inability to quickly and comprehensively understand domain-specific nuances hampers the development of robust predictive maintenance strategies, potentially leading to increased downtime, maintenance costs, and safety risks in industrial operations. Moreover, the lack of automated, intelligent question generation systems restricts the ability of organizations to rapidly adapt to new asset classes or emerging failure modes, potentially compromising their competitive edge in an increasingly data-driven industrial landscape.

Implementations of this disclosure address problems such as these by providing a multi-agent framework for domain-specific data generation that leverages AI agents to collaboratively generate, refine, and evaluate questions and answers tailored to industrial applications. This technical solution involves dynamic context discovery, iterative question refinement, and quality justification processes to enhance the efficiency and accuracy of domain knowledge acquisition for AI model development.

In some implementations, the system may receive input data indicative of a domain context, which may include an asset class, a problem type, or a data source associated with the domain context. For example, the input data may relate to a wind turbine gearbox in the context of predictive maintenance. The system may then determine a set of AI agent personas based on the domain context, with each persona associated with a predefined role. These personas may include, but are not limited to, a data scientist persona, an SME persona, a summarization persona, a question generation persona, or a question assignment persona. In some implementations, additional specialized personas tailored to specific industrial domains or tasks may be included.

The system may initialize a multi-agent framework comprising a plurality of AI agents, where each AI agent corresponds to a respective one of the set of AI agent personas. This framework may be instantiated using a set of large language models, enabling sophisticated natural language processing and generation capabilities. In some implementations, the system may generate an initial set of domain-specific questions based on the input data using various prompt generation techniques, such as zero-shot reasoning, in-context learning, or chain-of-thought prompting. These techniques allow the system to produce relevant and diverse questions even with limited initial context.

The multi-agent framework may assign each question from the initial set to at least one AI agent for processing, leveraging the specialized knowledge and capabilities of different personas. Through collaborative interactions, the AI agents may generate a refined set of questions, iteratively improving upon the initial set. This process may involve using responses from one AI agent to seed the generation of follow-up questions by another, simulating the back-and-forth of real-world expert collaborations. The system may also generate a set of answers corresponding to the refined questions, drawing upon domain-specific knowledge embedded within the AI agents.

To ensure the quality and relevance of the generated content, the system may employ various evaluation techniques. In some implementations, the quality of questions may be assessed using linguistic metrics (e.g., perplexity, type-token ratio) and semantic metrics (e.g., relevance scores, coherence measures). The system may filter questions to remove redundant or irrelevant content based on semantic similarity or heuristic thresholds, rank questions based on their relevance and importance to the domain context, and refine questions to improve linguistic clarity and coherence. Additionally, the system may validate refined questions using pre-trained classifiers to ensure they meet specific criteria, such as relevance, specificity, novelty, and logical consistency.

The multi-agent framework may execute interactions in multiple iterative rounds, each comprising steps such as routing questions to appropriate AI agents, generating responses, creating follow-up prompts, and applying filtering mechanisms. This iterative process allows for continuous refinement and expansion of the generated content, adapting to the complexities and nuances of the industrial domain. The system may store generated answers in a structured repository linked to corresponding questions, facilitating efficient retrieval and utilization of domain knowledge.

In some implementations, the system may leverage the generated questions and answers to produce specialized outputs for industrial applications. For example, an AI agent within the framework may generate a failure modes and effects analysis (FMEA) document based on the refined set of questions and answers. This capability demonstrates the system's potential to automate and enhance processes in industrial asset management and reliability engineering. In some implementations, applications may include generating maintenance predictions, anomaly detection reports, or other domain-specific analyses that leverage the collaboratively generated knowledge.

The multi-agent framework for domain-specific data generation represents a technical advancement over traditional knowledge acquisition methods by automating and optimizing the process of generating relevant, high-quality questions and answers for industrial AI applications. By simulating expert collaborations, ensuring linguistic and semantic quality, and providing mechanisms for continuous refinement, the system addresses the challenges of efficiently acquiring and leveraging domain-specific knowledge at scale. This technical solution enables organizations to rapidly adapt to new asset classes, emerging failure modes, and evolving industrial landscapes, ultimately enhancing the development of robust predictive maintenance strategies and improving operational efficiency and safety in industrial settings.

In some implementations, the multi-agent framework simulates real-world collaborative interactions between data scientists and SMEs. Accordingly, an advantage of the multi-agent framework is the ability to rapidly generate diverse, domain-specific questions without requiring extensive manual effort. Additionally, an advantage of the multi-agent framework is improved knowledge transfer between AI agents with different expertise, leading to more comprehensive and nuanced question generation. Furthermore, an advantage of the multi-agent framework is its scalability across various industrial domains and asset classes, enabling efficient knowledge acquisition for complex systems.

In some implementations, the system employs iterative refinement processes to continuously improve the quality and relevance of generated questions. Accordingly, an advantage of the iterative refinement processes is the ability to adapt to emerging insights and context discovered during the question generation process. Additionally, an advantage of the iterative refinement processes is the reduction of redundant or low-quality questions through sophisticated filtering mechanisms. Moreover, an advantage of the iterative refinement processes is the enhancement of linguistic diversity and technical depth in the generated questions, ensuring comprehensive coverage of domain-specific topics.

In some implementations, the system utilizes advanced evaluation metrics to assess the quality of generated questions and answers. Accordingly, an advantage of the advanced evaluation metrics is the ability to quantitatively measure the relevance and coherence of generated content in relation to the specific industrial domain. Additionally, an advantage of the advanced evaluation metrics is the facilitation of automated quality control, reducing the need for manual review and validation. Furthermore, an advantage of the advanced evaluation metrics is the potential for continuous improvement of the AI agents' performance through feedback loops based on quality assessments.

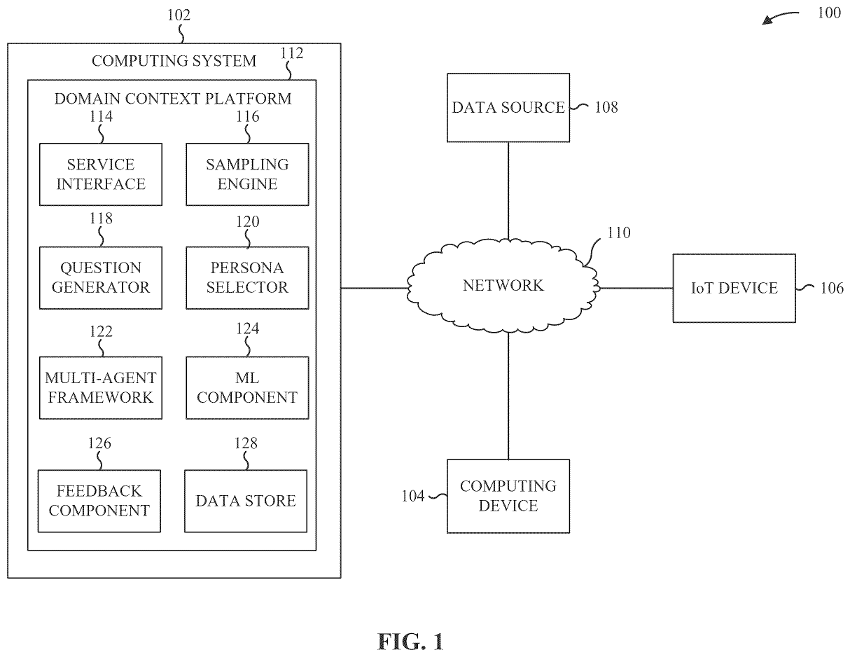

FIG. 1 illustrates a block diagram of an example computing environment 100 for implementing a multi-agent framework for domain-specific data generation. As shown, the computing environment 100 includes a computing system 102, a computing device 104, an IoT device 106, a data source 108, and a network 110 interconnecting these components. The computing system 102, computing device 104, IoT device 106, and data source 108 may be any type of computing device capable of connecting to the network 110. These devices may include servers, personal computers, laptops, smartphones, tablets, or specialized industrial equipment, among other examples. In some implementations, two or more of the computing system 102, computing device 104, IoT device 106, and data source 108 may be integrated or otherwise implemented on a common device or devices. In some implementations, one or more of these components may be implemented on separate devices, distributed among a plurality of devices, or implemented as virtual machines, among other examples. The network 110 may include one or more local area networks (LANs), wide area networks (WANs), or other types of networks, such as the Internet.

The computing system 102 includes a domain context platform 112 that includes multiple components for implementing the multi-agent framework for domain-specific data generation. The domain context platform 112 may be implemented as software and/or hardware using any number of computing devices, such as the computing system 102 or other devices in the computing environment 100. In some implementations, the domain context platform 112 may be distributed across multiple devices or implemented in a cloud computing environment.

The domain context platform 112 includes a service interface 114, a sampling engine 116, a question generator 118, a persona selector 120, a multi-agent framework 122, an ML component 124, a feedback component 126, and a data store 128. Any one or more of these components may be implemented using software and/or hardware on the same device or on separate devices or in a cloud computing environment. For example, two or more of the components 112-128 may be implemented by a single device or may be implemented on separate devices interconnected by one or more networks. In some implementations, some of these components may be implemented on the computing system 102, other components may be implemented on the computing device 104, and additional components may be implemented on the IoT device 106 or other devices. In some implementations, one or more of the sampling engine 116, the question generator 118, the persona selector 120, the ML component 124, the feedback component 126, and the data store 128 may be omitted or additional components may be added to the computing environment 100.

The service interface 114 may be configured to facilitate communication between the domain context platform 112 and other components of the computing environment 100. The service interface 114 may receive input data indicative of a domain context, such as an asset class, a problem type, or a data source associated with the domain context. This input data may be used to initialize and configure the multi-agent framework for a specific industrial domain or task.

The service interface 114 may be designed to handle various types of input data, including structured and unstructured data related to specific industrial domains, asset classes, or problem types. In some implementations, the service interface 114 may utilize standardized protocols and data formats to ensure seamless integration with diverse data sources and systems commonly found in industrial settings.

The service interface 114 may incorporate data preprocessing capabilities to normalize and validate incoming data before passing it to other components of the domain context platform 112. This preprocessing may include data cleansing, format conversion, and initial feature extraction to optimize the input for subsequent processing by the sampling engine 116 and other downstream components. In some implementations, the service interface 114 may implement security measures such as encryption and access control to protect sensitive industrial data during transmission and processing.

In some implementations, the service interface 114 may provide bidirectional communication capabilities, allowing it to not only receive input data but also transmit processed results and insights back to external systems or user interfaces. This bidirectional functionality may enable real-time feedback loops and iterative refinement of domain-specific questions and answers generated by the multi-agent framework. In some implementations, the service interface 114 may support multiple communication protocols and data exchange formats, enhancing its versatility and compatibility with a wide range of industrial systems and data sources.

A sampling engine 116 within the domain context platform 112 may be configured to process and analyze the input data received through the service interface 114. The sampling engine 116 may extract relevant features, patterns, or metadata from the input data to inform the generation of domain-specific questions and prompts. In some implementations, the sampling engine 116 may utilize various data preprocessing techniques, such as normalization, feature extraction, or dimensionality reduction, to prepare the input data for use by other components of the domain context platform 112.

The sampling engine 116 may employ various statistical and machine learning techniques to analyze and extract meaningful information from the input data. In some implementations, the sampling engine 116 may utilize stratified sampling methods to ensure representative subsets of data are selected across different categories or strata within the industrial domain. This approach may help maintain the diversity and proportional representation of various asset classes, failure modes, or operational conditions present in the original dataset.

The sampling engine 116 may incorporate adaptive sampling algorithms that dynamically adjust the sampling strategy based on the characteristics of the input data and the specific requirements of the domain context. For example, in cases where rare events or anomalies are of particular interest, the sampling engine 116 may implement oversampling techniques to increase the representation of these less frequent but potentially important data points. Additionally, the sampling engine 116 may leverage dimensionality reduction techniques such as principal component analysis (PCA) or t-distributed stochastic neighbor embedding (t-SNE) to identify and prioritize the most informative features within high-dimensional datasets.

In some implementations, the sampling engine 116 may incorporate domain-specific heuristics or expert knowledge to guide the sampling process. This may involve the use of predefined rules or weighting schemes that reflect the relative importance of different data attributes or patterns within the industrial context. The sampling engine 116 may also implement iterative sampling approaches, where initial samples are used to generate preliminary insights, which then inform subsequent sampling rounds to progressively refine and focus the data selection process. By employing these diverse sampling strategies, the sampling engine 116 may help ensure that the downstream components of the domain context platform 112 receive a rich and representative set of input data, facilitating the generation of high-quality, domain-specific questions and prompts.

The question generator 118 may be configured to generate a first set of domain-specific questions based on the input data processed by the sampling engine 116. The question generator 118 may employ various prompt generation techniques, such as zero-shot reasoning, in-context learning, or chain-of-thought prompting, to create diverse and relevant questions tailored to the specific domain context. In some implementations, the question generator 118 may utilize large language models or other AI technologies to facilitate the generation of contextually appropriate questions.

The question generator 118 may incorporate multiple strategies to produce a comprehensive set of domain-specific questions. In some implementations, the question generator 118 may utilize a combination of template-based approaches and dynamic generation techniques. Template-based methods may involve predefined question structures tailored to common industrial scenarios, which can be populated with domain-specific terminology and concepts extracted from the input data. Dynamic generation techniques may leverage advanced natural language processing models to create novel questions that explore nuanced aspects of the industrial domain.

In some implementations, the question generator 118 may implement a hierarchical approach to question generation, starting with high-level queries about general asset characteristics or operational parameters before delving into more specific inquiries about potential failure modes, maintenance procedures, or performance optimization strategies. This hierarchical structure may help ensure that the generated questions cover a wide range of relevant topics while maintaining a logical progression of inquiry depth. The question generator 118 may also incorporate feedback mechanisms that allow it to refine its output based on the quality and relevance of previously generated questions, as assessed by other components of the domain context platform 112.

The question generator 118 may be designed to adapt its output based on the specific requirements of different industrial domains or use cases. For example, when generating questions for predictive maintenance applications, the question generator 118 may focus on creating queries that explore historical failure patterns, sensor data correlations, or early warning indicators. In some implementations, when addressing quality control scenarios, the question generator 118 may produce questions that investigate process variables, material properties, or statistical process control methods. This adaptability may allow the question generator 118 to produce relevant and targeted questions across a diverse range of industrial contexts and problem types.

A persona selector 120 within the domain context platform 112 may be configured to determine a set of AI agent personas based on the domain context. Each AI agent persona may be associated with a predefined role, such as a data scientist persona, an SME persona, a summarization persona, a question generation persona, or a question assignment persona. The persona selector 120 may assign questions generated by the question generator 118 to appropriate AI agent personas for processing based on role-specific classifiers or other criteria.

The persona selector 120 may utilize any number of various algorithms and heuristics to match generated questions with suitable AI agent personas. In some implementations, the persona selector 120 may analyze the content, complexity, or domain-specific terminology of each question to determine which persona is appropriate to process it. For example, questions involving complex statistical analysis or machine learning concepts may be routed to a data scientist persona, while queries about specific industrial equipment or processes may be directed to a subject matter expert persona.

The persona selector 120 may consider the current state and workload of each AI agent persona when making assignment decisions. In some implementations, the persona selector 120 may implement load balancing techniques to distribute questions evenly among available personas, ensuring efficient processing and preventing bottlenecks. The persona selector 120 may additionally incorporate feedback mechanisms that allow it to learn from previous assignments and improve its matching accuracy over time. This adaptive approach may help optimize the overall performance of the multi-agent framework by leveraging the strengths of each persona and facilitating effective collaboration between different AI agents.

In some implementations, the persona selector 120 may support dynamic persona creation or modification based on emerging needs within the domain context. For instance, if the system encounters a new type of industrial asset or problem that requires specialized knowledge, the persona selector 120 may initiate the creation of a new AI agent persona with relevant expertise. This flexibility may allow the multi-agent framework to adapt to evolving industrial landscapes and maintain its effectiveness across a wide range of domain-specific scenarios.

The multi-agent framework 122 may be configured to initialize and manage a plurality of AI agents corresponding to the AI agent personas determined by the persona selector 120. The multi-agent framework 122 may facilitate collaborative interactions among the AI agents to refine and expand upon the initial set of domain-specific questions. In some implementations, the multi-agent framework 122 may be instantiated using a set of large language models, enabling sophisticated natural language processing and generation capabilities across different agent roles.

The multi-agent framework 122 may be designed to orchestrate interactions between diverse AI agents, each representing a specialized role or expertise within the industrial domain. The multi-agent framework 122 may facilitate dynamic collaboration and knowledge sharing among the AI agents, allowing them to collectively tackle complex domain-specific problems that may be challenging for a single agent to address. In some implementations, the multi-agent framework 122 may employ coordination mechanisms, such as hierarchical planning or decentralized decision-making protocols, to efficiently manage the distributed processing of questions and generation of insights.

The multi-agent framework 122 may incorporate adaptive learning capabilities that allow it to evolve and improve its performance over time. As the AI agents interact and process domain-specific questions, the multi-agent framework 122 may capture and analyze the outcomes of these interactions, identifying successful patterns and strategies. This accumulated knowledge may be used to refine the decision-making processes of individual agents or optimize the overall collaboration dynamics within the framework. In some implementations, the multi-agent framework 122 may implement reinforcement learning techniques to continually, periodically, or in response to a trigger event, adjust its internal policies and reward structures, encouraging behaviors that lead to more accurate and relevant question refinement and answer generation.

In some implementations, the multi-agent framework 122 may support the integration of external knowledge sources or expert systems to enhance its domain-specific capabilities. This may involve interfacing with industrial databases, equipment manuals, or real-time sensor data to provide the AI agents with up-to-date contextual information. The multi-agent framework 122 may facilitate the incorporation of human expertise through interactive feedback loops, allowing domain experts to guide and validate the agents' outputs. This hybrid approach may help the multi-agent framework 122 to combine the scalability and processing power of AI with the nuanced understanding and experience of human experts, which may facilitate robust and trustworthy outcomes in complex industrial scenarios.

The ML component 124 may be configured to support various machine learning tasks related to the multi-agent framework and question generation process. An ML component refers to hardware and/or software capable of performing ML. ML is a subset of AI that involves the development of algorithms and statistical models enabling computers to perform tasks without explicit programming. ML leverages large datasets to identify patterns, make decisions, and improve over time based on experience. ML focuses on creating systems that can learn from data, adapt to new inputs, and generate predictions or actions.

For example, an ML component may be or include one or more ML models, ML algorithms, and/or ML systems including combinations of ML algorithms and ML models. An ML component may be implemented on any number of different hardware devices and may include one or more machine learning models. ML is a field of study that gives computers the ability to perform certain tasks without being explicitly programmed to perform those tasks. In traditional computing, a programmer would encode instructions (e.g., to solve a quadratic equation using the quadratic formula), and the computer would perform those exact instructions. In contrast, in ML, a computer can be provided with examples and be trained to perform a task such as prediction or classification, without the programmer encoding explicit instructions for the task. ML explores the study and construction of algorithms, also referred to herein as tools, models, and/or components, which may learn from existing data and make predictions about new data. Such ML tools operate by building a model from example training data in order to make data-driven predictions or decisions expressed as outputs or assessments. Although example embodiments are presented with respect to a few ML models, the principles presented herein may be applied to other ML models. In some example embodiments, different ML models may be used. ML models may include, for example, K-means clustering models, linear regression models, logistic regression (LR) models, Naive-Bayes models, random forest (RF) regression models, gradient boost models, neural networks (NN), matrix factorization models, large language models (LLMs), and/or support vector machines (SVMs), among other examples.

Two common types of problems in ML are classification problems and regression problems. Classification problems, also referred to as categorization problems, aim at classifying items into one of several category values (for example, is this object an apple or an orange). Regression algorithms aim at quantifying some items (for example, by providing a value that is a real number). ML components utilize training data to find correlations among identified features that affect the outcome. For example, ML components utilize features for analyzing the data to generate assessments. A feature is an individual measurable property of a phenomenon being observed. The concept of a feature is related to that of an explanatory variable used in statistical techniques such as linear regression. Choosing informative, differentiating, and independent features is important for effective operation of the ML component in pattern recognition, classification, and regression. Features may be of different types, such as numeric features, strings, and graphs.

ML components utilize the training data to find correlations among the identified features that affect the outcome or assessment. In some example embodiments, the training data includes labeled data, which is known data for one or more identified features and one or more outcomes. With the training data and the identified features, the ML component may be trained. The ML component appraises the value of the features as they correlate to the training data. The result of the training is the trained ML component. When the ML component is used to perform an assessment, new data is provided as an input to the trained ML component, and the ML component generates an assessment as output.

ML techniques train models to accurately make predictions on data fed into the models (e.g., what was said by a user in a given utterance; whether a noun is a person, place, or thing; what the weather will be like tomorrow). During a learning phase, the models are developed against a training dataset of inputs to optimize the models to correctly predict the output for a given input. Generally, the learning phase may be supervised, semi-supervised, or unsupervised; indicating a decreasing level to which the “correct” outputs are provided in correspondence to the training inputs. In a supervised learning phase, all of the outputs are provided to the model and the model is directed to develop a general rule or algorithm that maps the input to the output. In contrast, in an unsupervised learning phase, the desired output is not provided for the inputs so that the model may develop its own rules to discover relationships within the training dataset. In a semi-supervised learning phase, an incompletely labeled training set is provided, with some of the outputs known and some unknown for the training dataset.

Models may be run against a training dataset for several epochs (e.g., iterations), in which the training dataset is repeatedly fed into the model to refine its results. For example, in a supervised learning phase, a model is developed to predict the output for a given set of inputs, and is evaluated over several epochs to more reliably provide the output that is specified as corresponding to the given input for the greatest number of inputs for the training dataset. In another example, for an unsupervised learning phase, a model is developed to cluster the dataset into n groups, and is evaluated over several epochs as to how consistently it places a given input into a given group and how reliably it produces the n desired clusters across each epoch.

Once an epoch is run, the models are evaluated and the values of their variables are adjusted to attempt to better refine the model in an iterative fashion. In various aspects, the evaluations are biased against false negatives, biased against false positives, or evenly biased with respect to the overall accuracy of the model. The values may be adjusted in several ways depending on the ML technique used. For example, in a genetic or evolutionary algorithm, the values for the models that are most successful in predicting the desired outputs are used to develop values for models to use during the subsequent epoch, which may include random variation/mutation to provide additional data points.

Each model develops a rule or algorithm over several epochs by varying the values of one or more variables affecting the inputs to more closely map to a desired result, but as the training dataset may be varied, and is preferably very large, perfect accuracy and precision may not be achievable. A number of epochs that make up a learning phase, therefore, may be set as a given number of trials or a fixed time/computing budget, or may be terminated before that number/budget is reached when the accuracy of a given model is high enough or low enough or an accuracy plateau has been reached. For example, if the training phase is designed to run n epochs and produce a model with at least 95% accuracy, and such a model is produced before the nth epoch, the learning phase may end early and use the produced model satisfying the end-goal accuracy threshold. Similarly, if a given model is inaccurate enough to satisfy a random chance threshold (e.g., the model is only 55% accurate in determining true/false outputs for given inputs), the learning phase for that model may be terminated early, although other models in the learning phase may continue training. Similarly, when a given model continues to provide similar accuracy or vacillate in its results across multiple epochs—having reached a performance plateau—the learning phase for the given model may terminate before the epoch number/computing budget is reached.

Once the learning phase is complete, the models are finalized. In some example embodiments, models that are finalized are evaluated against testing criteria. In a first example, a testing dataset that includes known outputs for its inputs is fed into the finalized models to determine an accuracy of the model in handling data that it has not been trained on. In a second example, a false positive rate or false negative rate may be used to evaluate the models after finalization. In a third example, a delineation between data clusterings is used to select a model that produces the clearest bounds for its clusters of data.

ML models may be implemented for use in a variety of use cases (e.g., language processing, image feature extraction, cyberthreat detection, or recommendation production), using a variety of approaches (e.g., supervised learning, unsupervised learning, or reinforcement learning), and in a variety of structures (e.g., a neural network, decision tree, linear regression, vector machine, Bayesian network, genetic algorithm, or deep learning system).

In the realm of natural language processing (NLP), ML training software can employ a learning paradigm focused on human preferences to better align pretrained and instruction-tuned generative language models with human values. This process involves the ML training software collecting extensive data, where each data point comprises a context, pairs of continuations of the context (generations), and a pairwise human preference indicating the superior generation. Subsequently, the ML training software learns to generate optimal continuations for a given context based on the collected data.

In some cases, the ML training software may employ reinforcement learning (RL), which is a method of training neural networks that may be used, for example, for training LLMs. Similar to human learning, RL trains neural networks through trial and error. Specifically, the neural network produces an output, receives feedback regarding this output, and then learns from the feedback. For instance, when finetuning a language model using reinforcement learning from human feedback (RLHF), the language model generates text and receives a score or reward from a human annotator, which reflects the quality of the text. The AI training software then employs RL to finetune the language model to generate outputs with high scores.

Reinforcement learning proves to be an advantageous and promising learning algorithm for neural networks because it allows learning from non-differentiable signals, which are incompatible with supervised learning. This capability enables the AI training software to learn from arbitrary feedback on a neural network's output. In the case of RLHF, the outputs generated by a language model can be scored according to any predefined principle. The AI training software then uses RL to learn from these scores, regardless of their definition.

Problems addressed via RL are typically structured in a consistent format. Specifically, an agent interacts with an environment, maintaining a state within this environment and producing actions that can alter the current state. As the agent interacts with the environment, it can receive both positive and negative rewards for its actions. The agent's objective is to maximize the rewards received, although not every action is associated with a reward. Rewards may have a long horizon, necessitating several correct, consecutive actions to generate any positive reward. In mathematical terms, RL may be described as a Markov decision process (MDP). An MDP includes states, actions, rewards, transitions, and a policy. States and actions have discrete values, while rewards are real numbers. In an MDP, a policy (referred to herein, interchangeably as a “policy model”) takes a state as input and outputs a probability distribution over possible actions. Given this output, a decision can be made for the action to be taken from a current state, and the transition is then a function that outputs the next state based upon the prior state and chosen action. Using these components, the agent can interact with the environment in an iterative fashion to generate a trained policy.

The ML component 124 may include pre-trained models, such as classifiers for assessing question quality or relevance, as well as algorithms for continually improving the performance of the AI agents based on feedback and interactions. In some implementations, the ML component 124 may facilitate transfer learning or fine-tuning of models to adapt to specific domain contexts or industrial applications.

The ML component 124 may include one or more LLMs. These LLMs may serve as the foundation for creating AI agents within the multi-agent framework. In some implementations, each AI agent may be instantiated as an LLM-based agent, leveraging the natural language processing and generation capabilities of the underlying LLM.

LLM-based agents may operate by receiving input in the form of natural language prompts or structured data, processing this information through the LLM, and generating appropriate responses or actions based on their specialized roles and the context of the task. For example, a data scientist agent may utilize an LLM to analyze complex datasets, generate statistical insights, and formulate relevant questions for further investigation. Similarly, an SME agent may leverage an LLM to provide domain-specific knowledge, interpret technical terminology, and offer explanations tailored to the industrial context.

In some aspects, the LLM-based agents may employ techniques such as few-shot learning or in-context learning, allowing them to adapt to new tasks or domains with minimal additional training. This adaptability may be particularly useful in industrial settings where the agents need to handle diverse asset classes, failure modes, or operational scenarios.

The multi-agent framework may facilitate interactions between these LLM-based agents by orchestrating the flow of information and prompts between them. For instance, a question generated by one agent may be routed to another agent for refinement or answering, with the interactions mediated through natural language exchanges processed by the respective LLMs.

In some implementations, the ML component 124 may utilize different types or sizes of LLMs for different agents or tasks, optimizing the balance between computational resources and performance. For example, a summarization agent may use a smaller, more specialized LLM focused on text condensation, while a complex reasoning agent may employ a larger, more general-purpose LLM.

The use of LLM-based agents may allow for dynamic role-switching or multi-role capabilities, where a single agent can adapt its behavior based on the current context or requirements of the task. This flexibility may enhance the overall efficiency and adaptability of the multi-agent framework in handling diverse industrial scenarios and generating domain-specific questions and insights.

The ML component 124 may function as a processing center for machine learning operations within the domain context platform 112. This component may incorporate various pre-trained models and algorithms designed to support the multi-agent framework in generating and refining domain-specific questions and answers. The ML component 124 may include classifiers that assess the quality and relevance of generated questions, helping to ensure that the output aligns with the specific industrial domain and user requirements.

In some implementations, the ML component 124 may employ transfer learning techniques to adapt existing models to new domain contexts or industrial applications. This approach may allow the system to leverage knowledge gained from one task or domain to improve performance on related tasks, potentially reducing the amount of training data required for new applications. The ML component 124 may also facilitate fine-tuning of models, allowing for incremental adjustments to pre-trained models to better suit the nuances of specific industrial scenarios or asset classes.

The ML component 124 may, continually, periodically, or in response to a trigger event, improve the performance of AI agents within the multi-agent framework through iterative learning processes. It may analyze feedback from interactions between agents, as well as from external sources such as user input or real-world performance metrics. This ongoing refinement may enable the system to adapt to changing conditions, emerging failure modes, or new types of industrial assets over time. The ML component 124 may also implement reinforcement learning techniques, potentially allowing AI agents to learn optimal strategies for generating and refining questions through trial and error interactions within the simulated multi-agent environment.

The feedback component 126 may be configured to evaluate the quality and relevance of generated questions and answers. The feedback component 126 may utilize various evaluation metrics, such as linguistic metrics (e.g., perplexity, type-token ratio) and semantic metrics (e.g., relevance scores, coherence measures), to assess the generated content. This component may facilitate automated quality control and enable continuous improvement of the AI agents' performance through feedback loops based on quality assessments.

The feedback component 126 may evaluate and improve the quality of generated questions and answers within the multi-agent framework. The feedback component 126 may employ a diverse set of evaluation metrics to assess the linguistic or semantic aspects of the generated content. Linguistic metrics such as perplexity and type-token ratio may be used to evaluate the fluency and diversity of the language, while semantic metrics including relevance scores and coherence measures may help determine how well the generated content aligns with the specific industrial domain and user requirements.

In some implementations, the feedback component 126 may incorporate machine learning models trained on domain-specific data to provide more nuanced assessments of content quality. These models may be capable of identifying subtle domain-specific nuances or technical accuracy that might be missed by more general evaluation metrics. The feedback component 126 may leverage user feedback and expert annotations to refine its evaluation criteria, which may help the system to adapt to evolving industry standards and user preferences over time.

The insights generated by the feedback component 126 may be used to create feedback loops within the multi-agent framework, enabling continual or periodic improvement of AI agent performance. For example, questions or answers that receive low quality scores may be flagged for review or regeneration, while high-scoring content may be used to reinforce successful generation strategies. In some implementations, the feedback component 126 may provide detailed breakdowns of its assessments, highlighting specific areas for improvement such as technical accuracy, relevance to the asset class, or clarity of expression. This granular feedback may facilitate targeted refinement of the AI agents' generation capabilities, potentially leading to more efficient and effective domain-specific question and answer generation over time.

A data store 128 within the domain context platform 112 may be configured to store various types of data related to the multi-agent framework and question generation process. This may include input data, generated questions and answers, AI agent configurations, evaluation metrics, or other relevant information. In some implementations, the data store 128 may serve as a structured repository for linking generated answers to corresponding questions, facilitating efficient retrieval or utilization of domain knowledge.

The computing device 104 may be configured to interact with the domain context platform 112 through the network 110, potentially serving as a user interface for data scientists, engineers, or other stakeholders involved in the domain-specific data generation process. The computing device 104 may send input data, receive generated questions and answers, and provide feedback or additional context to refine the output of the multi-agent framework.

The IoT device 106 may represent industrial sensors, actuators, or other connected devices that provide real-time data relevant to the domain context. This device may continually, periodically, or in response to trigger events send operational data, sensor readings, or status information to the domain context platform 112, enriching the input data available for question generation and analysis.

The data source 108 may be configured to provide additional domain-specific information, such as historical data, technical documentation, or industry standards, to supplement the input data and enhance the context available to the multi-agent framework. This data source may be continually updated and may include structured databases, unstructured text repositories, or other forms of information storage relevant to the industrial domain.

In operation, the domain context platform 112 may receive input data from various sources, including the computing device 104, IoT device 106, and data source 108. The sampling engine 116 may process this input data, extracting relevant features and context. The question generator 118 may then create an initial set of domain-specific questions, which are assigned to appropriate AI agent personas by the persona selector 120. The multi-agent framework 122 may facilitate collaborative interactions among the AI agents to refine and expand upon these questions, potentially generating follow-up questions based on initial responses or extracted context.

Throughout this process, the ML component 124 may provide support for various machine learning tasks, such as classifying questions or improving agent performance. The feedback component 126 may continually evaluate the quality and relevance of generated content, providing insights for iterative refinement. The data store 128 may maintain a structured repository of questions, answers, and associated metadata, enabling efficient retrieval and utilization of the generated domain knowledge.

The multi-agent framework implemented by the domain context platform 112 may execute interactions in multiple iterative rounds, each comprising steps such as routing questions to appropriate AI agents, generating responses, creating follow-up prompts, and applying filtering mechanisms. This iterative process may allow for continuous refinement and expansion of the generated content, adapting to the complexities and nuances of the industrial domain.

In some implementations, the domain context platform 112 may leverage the generated questions and answers to produce specialized outputs for industrial applications. For example, an AI agent within the multi-agent framework 122 may generate an FMEA document based on the refined set of questions and answers. Other potential applications may include generating maintenance predictions, anomaly detection reports, or other domain-specific analyses that leverage the collaboratively generated knowledge.

The computing environment 100 and its components, as described, represent a technical advancement over traditional knowledge acquisition methods by automating and optimizing the process of generating relevant, high-quality questions and answers for industrial AI applications. By simulating expert collaborations, ensuring linguistic and semantic quality, and providing mechanisms for continuous refinement, the system may address the challenges of efficiently acquiring and leveraging domain-specific knowledge at scale, ultimately enhancing the development of robust predictive maintenance strategies and improving operational efficiency and safety in industrial settings.

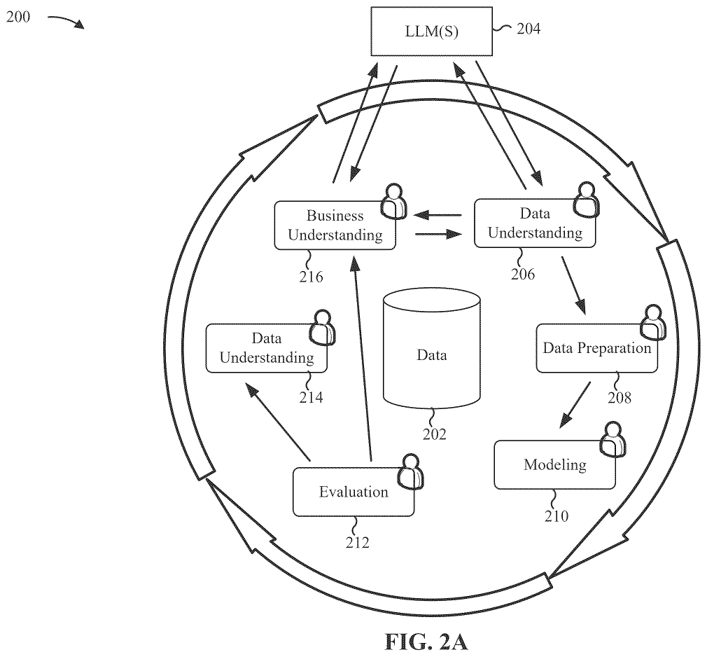

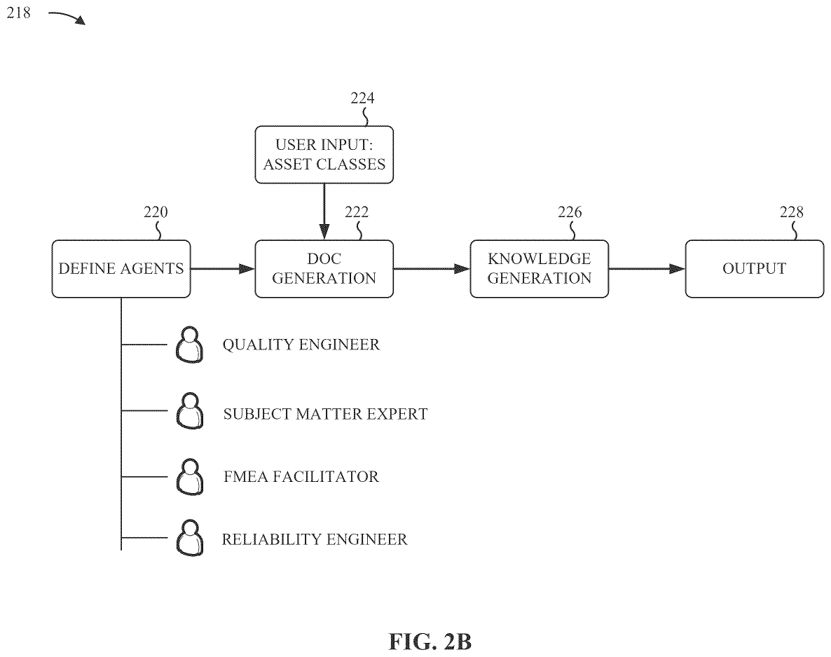

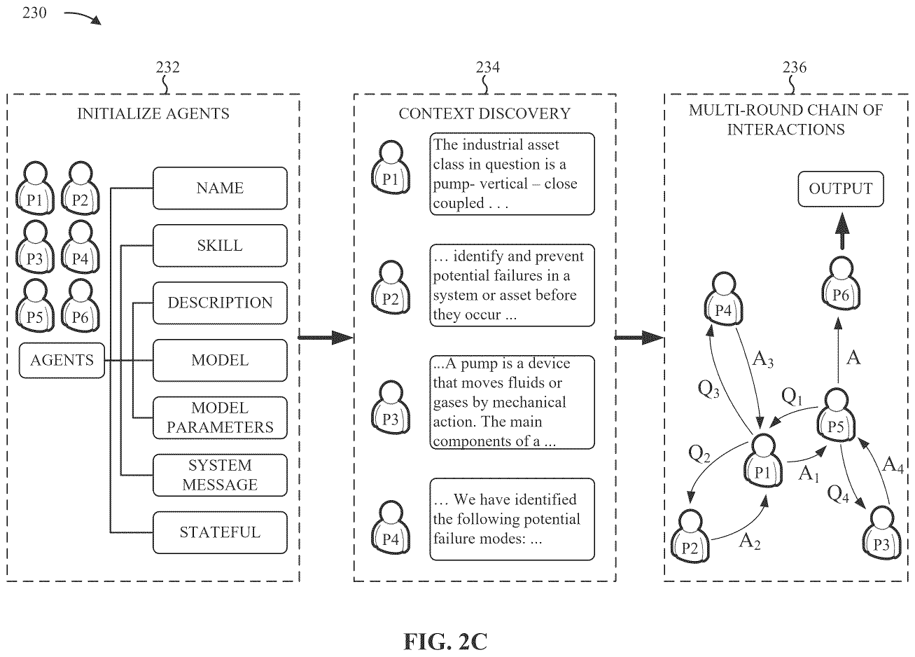

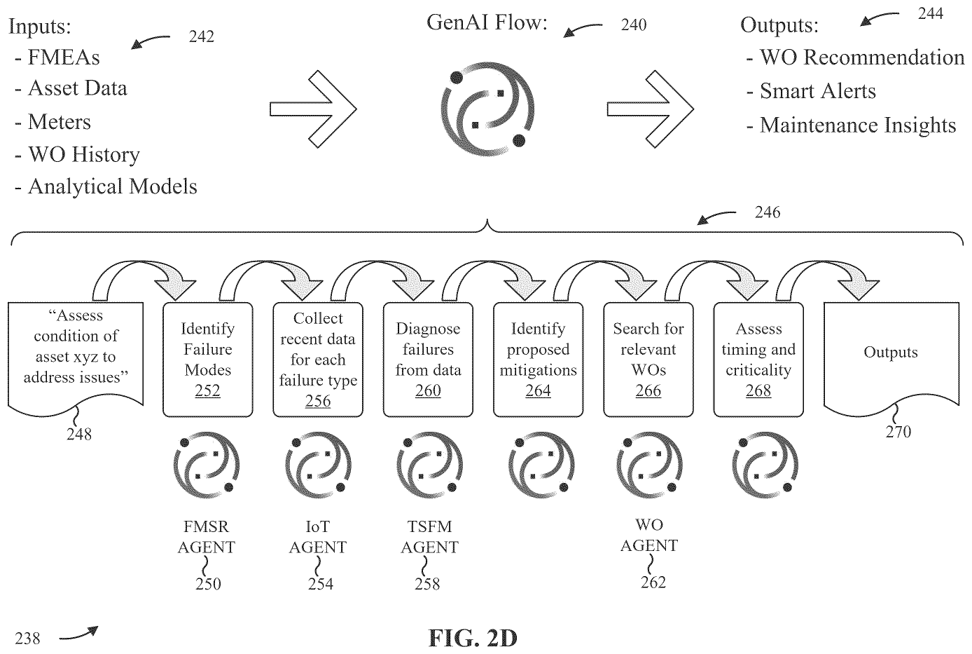

FIG. 2A illustrates an example methodology 200 that may be associated with implementing a multi-agent framework for domain-specific data generation. The methodology 200 may facilitate processing of data 202 using ne or more LLMs 204.

The methodology 200 may include several operations such as a data understanding operation 206, a data preparation operation 208, a modeling operation 210, and an evaluation operation 212. Additional operations may include another data understanding operation 214 and a business understanding operation 216.

In some implementations, the data understanding operation 206 may be configured to analyze and interpret the input data received by the system. This operation may involve techniques such as data profiling, statistical analysis, or exploratory data visualization to gain insights into the characteristics and structure of the data.

The data preparation operation 208 may be configured to preprocess and transform the input data into a format suitable for modeling. This may include tasks such as data cleaning, normalization, feature engineering, or handling missing values.

The modeling operation 210 may be configured to apply machine learning algorithms or other analytical techniques to the prepared data. This operation may involve training models, tuning hyperparameters, or implementing ensemble methods to generate predictive or descriptive models.

The evaluation operation 212 may be configured to assess the performance and validity of the models generated in the modeling operation 210. This may include techniques such as cross-validation, statistical testing, or comparison against baseline models.

The business understanding operation 216 may be configured to align the technical aspects of the methodology with the business objectives and domain context. This operation may involve defining project goals, identifying performance indicators, or translating business requirements into technical specifications.

The one or more LLMs 204 may be configured to support various aspects of the methodology 200. For example, they may assist in natural language processing tasks, generate domain-specific questions, or provide contextual information to enhance the understanding and modeling processes.

In some implementations, the circular arrangement of operations in the methodology 200 may facilitate an iterative approach to domain-specific data generation. This structure may allow for continual and iterative refinement and improvement of the generated data and models as new insights are gained through each cycle of the process.

The methodology 200 may be designed to address the challenges of efficiently acquiring and leveraging domain-specific knowledge for industrial AI applications. By integrating multiple operations and leveraging advanced language models, the methodology may enhance the development of robust predictive maintenance strategies and improve operational efficiency in industrial settings.

FIG. 2B illustrates a flowchart of an example implementation 218 associated with a multi-agent framework for domain-specific data generation. In some implementations, one or more aspects of example implementation 218 may be performed by the domain context platform 112 described in connection with FIG. 1.

The example implementation 218 begins with a user input operation 224 labeled “USER INPUT: ASSET CLASSES” which provides initial asset class information to the system. This user input may include data indicative of a domain context, such as an asset class, a problem type, or a data source associated with the domain context. The user input operation 224 may facilitate the initialization of the multi-agent framework by providing context for the subsequent operations.

The implementation includes a define agents operation 220. The define agents operation 220 may be configured to determine a set of AI agent personas based on the domain context provided by the user input. Each AI agent persona may be associated with a predefined role within the domain-specific task environment. In some implementations, the define agents operation 220 may select at least two personas from a set of personas, which may include a data scientist persona, an SME persona, a summarization persona, a question generation persona, or a question assignment persona.

The define agents operation 220 shows multiple agent roles arranged vertically, including a quality engineer, subject matter expert, FMEA facilitator, and reliability engineer. These roles represent different AI agent personas that may be initialized as part of the multi-agent framework. Each of these personas may be configured to perform specific tasks or provide specialized knowledge within the context of the domain-specific data generation process.

After the define agents operation 220, the implementation includes a document generation operation 222 labeled “DOC GENERATION.” The document generation operation 222 may be configured to generate a first set of domain-specific questions based on the input data and the defined agent personas. In some implementations, the document generation operation 222 may apply at least one prompt generation technique, such as a zero-shot reasoning technique, an in-context learning technique, or a chain-of-thought prompting technique to create diverse and relevant questions tailored to the specific domain context.

The document generation operation 222 may involve assigning each question of the first set of domain-specific questions to at least one AI agent of the plurality of AI agents for processing. This assignment process may be based on role-specific classifiers or other criteria that match the content and complexity of each question to the most appropriate AI agent persona.

Following the document generation operation 222, the implementation includes a knowledge generation operation 226 labeled “KNOWLEDGE GENERATION.” The knowledge generation operation 226 may be configured to facilitate collaborative generation of a second set of questions by the plurality of AI agents. This collaborative process may involve refinement of the first set of domain-specific questions and interactions among the plurality of AI agents.

In some implementations, the knowledge generation operation 226 may use at least one response from a first AI agent to seed generation of a follow-up question by a second AI agent. This iterative process may allow for continuous refinement and expansion of the generated content, adapting to the complexities and nuances of the industrial domain.

The knowledge generation operation 226 may also involve generating a set of answers corresponding to the second set of questions based on domain-specific knowledge. These answers may be generated by the multi-agent framework, leveraging the specialized expertise of each AI agent persona within the framework.

The implementation includes an output operation 228 labeled “OUTPUT.” The output operation 228 may be configured to output a set of output data comprising at least one of the first set of domain-specific questions, the second set of questions, or the set of answers for use by a downstream application. This output may serve as input for various industrial applications, such as predictive maintenance, anomaly detection, or reliability analysis.

In some implementations, the output operation 228 may include storing the set of answers in a structured repository linked to corresponding questions. This structured storage may facilitate efficient retrieval and utilization of the generated domain knowledge for future use or analysis.

The example implementation 218 may be designed to address the challenges of efficiently acquiring and leveraging domain-specific knowledge for industrial AI applications. By integrating multiple operations and leveraging a multi-agent framework, the implementation may enhance the development of robust predictive maintenance strategies and improve operational efficiency in industrial settings.

The example implementation 218 may also include mechanisms for ensuring the quality of the generated questions and answers. This may involve evaluating the quality of at least one question using linguistic metrics or semantic metrics. Additionally, the system may filter, rank, and refine questions to improve their relevance, specificity, and coherence within the domain context.

In some implementations, an AI agent within the multi-agent framework may be configured to generate an FMEA document based on the generated questions and answers. This capability demonstrates the potential of the system to automate and enhance processes in industrial asset management and reliability engineering.

FIG. 2C illustrates an example 230 of a system for processing domain-specific questions and interactions. The example 230 includes three main operations: an initialize agents operation 232, a context discovery operation 234, and a multi-round chain of interactions operation 236.

The initialize agents operation 232 may be configured to set up multiple agents (P1-P6) with various attributes including NAME, SKILL, DESCRIPTION, MODEL, MODEL PARAMETERS, SYSTEM MESSAGE, and STATEFUL parameters. This initialization process may facilitate the creation of specialized AI agents tailored to specific roles within the domain-specific task environment.

The context discovery operation 234 may display agents P1-P4 with associated text content. Agent P1 may generate text regarding an industrial asset class, which may provide foundational information for the domain context. Agent P2 may generate text about identifying and preventing potential failures, which may be relevant for reliability analysis and predictive maintenance applications. Agent P3 may generate information about pump functionality and components, offering detailed domain knowledge about a specific type of industrial equipment. Agent P4 may generate text related to identified potential failure modes, which may be useful for failure analysis and risk assessment.

The multi-round chain of interactions operation 236 may depict a network of interactions between agents P1-P6. The diagram shows various connections labeled with “A” and “Q” indicators between the agents, which may represent different types of interactions such as questions and answers. Agent P6 is shown connected to an OUTPUT, which may indicate the final processing or aggregation of information generated through the multi-agent interactions.

In some implementations, the initialize agents operation 232 may leverage large language models or other AI technologies to create agents with sophisticated natural language processing and generation capabilities. The context discovery operation 234 may employ techniques such as zero-shot learning or few-shot learning to rapidly adapt the agents to the specific industrial domain context provided by the input data.

The multi-round chain of interactions operation 236 may implement various collaboration mechanisms to facilitate effective knowledge sharing and question refinement among the AI agents. For example, the system may use techniques such as dynamic message routing or attention mechanisms to direct queries to the most appropriate agent based on their specialized knowledge or role.

In some implementations, the system may incorporate feedback loops within the multi-round chain of interactions operation 236. These feedback loops may allow the system to continually, periodically, or in response to a trigger event refine the generated questions and answers based on the quality and relevance of previous interactions. This iterative refinement process may help ensure that the final output is well-tailored to the specific needs of the industrial domain and downstream applications.

The example 230 may be designed to address challenges in efficiently acquiring and leveraging domain-specific knowledge for industrial AI applications. By simulating collaborative interactions between specialized AI agents, the system may enhance the development of robust predictive maintenance strategies, failure analysis capabilities, and other functions in industrial asset management.

FIG. 2D illustrates a flowchart of an example 238 associated with a generative AI flow 240 for processing input data and generating outputs. The generative AI flow 240 may be configured to receive inputs 242 comprising FMEAs, asset data, meters, work order (WO) history, and analytical models. These inputs 242 may be provided to the system for further processing and analysis.

The representation 246 shows a sequence of operations performed on a set of input data 248. The sequence may begin with an initial assessment that may facilitate the identification of potential problems or areas of concern related to the asset. Following the initial assessment, the process may flow through multiple operations, each supported by different agents. A Failure Mode and Severity Rating (FMSR) agent 250 may be configured to support the operation 252 to identify failure modes. This operation may involve analyzing the asset data to determine potential ways in which the asset could fail or malfunction.

An IoT agent 254 may be configured to support the operation 256 to collect data for each failure type. This operation may involve gathering relevant sensor data or other information specific to the identified failure modes, which may facilitate more detailed analysis and understanding of the asset's condition.

A TSFM agent 258 may be configured to support the operation 260 to diagnose failures from data. This operation may involve applying analytical techniques to the collected data to determine the root causes or specific characteristics of potential failures.

A work order (WO) agent 262 may be configured to support the operation 264 to identify proposed mitigations. This operation may involve generating recommendations for maintenance actions or interventions based on the diagnosed failures and historical work order data.

The sequence may continue with operation 266 to search for relevant WOs. This operation may involve querying historical work order databases to find similar past issues and their resolutions, which may inform current decision-making processes.

Operation 268 may be configured to assess timing and criticality. This operation may involve evaluating the urgency and importance of identified issues, potentially prioritizing maintenance actions based on their potential impact on asset performance or safety.

The process may conclude with output data 270, which may represent the culmination of the analysis and decision-making processes performed by the various agents and operations.

The generative AI flow 240 may be configured to produce outputs 244 comprising WO recommendations, smart alerts, and maintenance insights. These outputs may provide actionable information for asset managers, maintenance personnel, or other stakeholders involved in managing the industrial asset.

In some implementations, the example 238 may demonstrate how multiple specialized agents work in sequence to process input data and generate actionable outputs related to asset maintenance and failure analysis. This multi-agent approach may facilitate a comprehensive and nuanced analysis of complex industrial assets, potentially improving the accuracy and relevance of maintenance recommendations and insights.

The generative AI flow 240 may be designed to address challenges in efficiently processing and analyzing large volumes of asset-related data. By leveraging specialized agents for different aspects of the analysis, the system may enhance the development of robust predictive maintenance strategies, failure analysis capabilities, and other functions in industrial asset management.

In some implementations, the generative AI flow 240 may be integrated with other components of a larger system, such as the multi-agent framework described in connection with FIG. 1. This integration may facilitate the exchange of information between different parts of the system, potentially enhancing the overall capabilities for domain-specific data generation and analysis in industrial contexts.

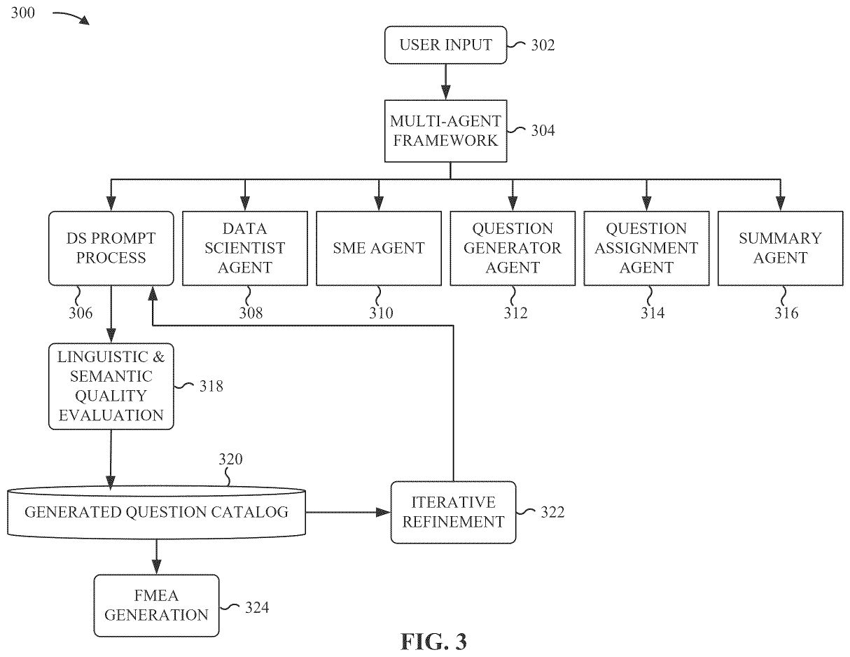

FIG. 3 illustrates a diagram of an example 300 of a data flow associated with a multi-agent framework for domain-specific data generation. In some implementations, one or more aspects of example 300 may be performed by the domain context platform 112 described in connection with FIG. 1.

The example 300 begins with user input 302 being received by a multi-agent framework 304. The user input 302 may include data indicative of a domain context, such as an asset class, a problem type, or a data source associated with the domain context. The multi-agent framework 304 may be configured to process this input and facilitate collaborative interactions among multiple AI agents to generate domain-specific questions and answers.

The multi-agent framework 304 may be instantiated using a set of large language models, enabling sophisticated natural language processing and generation capabilities. In some implementations, the multi-agent framework 304 may include multiple components that process the user input 302, such as a domain-specific prompt process 306, a data scientist agent 308, an SME agent 310, a question generator agent 312, a question assignment agent 314, and a summary agent 316.

The domain-specific prompt process 306 may be configured to generate an initial set of domain-specific questions based on the user input 302. This process may apply various prompt generation techniques, such as zero-shot reasoning, in-context learning, or chain-of-thought prompting, to create diverse and relevant questions tailored to the specific domain context.

The data scientist agent 308 may be configured to operate in accordance with a data scientist persona, corresponding to a predefined role within the domain-specific task environment. This agent may be responsible for generating model-related queries and analyzing complex datasets to formulate relevant questions for further investigation.

The SME agent 310 may be configured to operate in accordance with an SME persona. This agent may be responsible for providing domain-specific answers and interpreting technical terminology related to the industrial context. The SME agent 310 may leverage its specialized knowledge to refine and expand upon the initial set of domain-specific questions.

The question generator agent 312 may be configured to generate additional questions based on the context and responses provided by other agents. This agent may use techniques such as few-shot learning or in-context learning to adapt to new tasks or domains with minimal additional training.

The question assignment agent 314 may be configured to assign questions to appropriate AI agent personas for processing. This assignment may be based on role-specific classifiers or other criteria that match the content and complexity of each question to the most suitable AI agent persona.

The summary agent 316 may be configured to condense input context or responses, providing concise summaries of the generated questions and answers. This agent may facilitate the efficient exchange of information between different parts of the multi-agent framework.

The domain-specific prompt process 306 may connect to a linguistic and semantic quality evaluation process 318. This process may be configured to evaluate the quality of generated questions using various metrics, such as perplexity, type-token ratio, relevance scores, or coherence measures. The quality evaluation process 318 may facilitate automated quality control and enable continuous improvement of the AI agents' performance through feedback loops based on quality assessments.

The quality evaluation process 318 may feed into a generated question catalog 320. This catalog may serve as a structured repository for storing and refining domain-specific questions. In some implementations, the generated question catalog 320 may link generated answers to corresponding questions, facilitating efficient retrieval and utilization of domain knowledge.

The question catalog 320 may connect to an iterative refinement operation 322. This operation may be configured to continually, periodically, or in response to a trigger event, improve the quality and relevance of generated questions. The iterative refinement operation 322 may receive input from multiple sources, including the SME agent 310, to enhance the diversity and depth of the generated questions.

The iterative refinement operation 322 may involve filtering questions to remove redundant or irrelevant content based on semantic similarity or heuristic thresholds. It may also rank questions based on their relevance and importance to the domain context. Additionally, the operation may refine questions to improve linguistic clarity and coherence.

In some implementations, the iterative refinement operation 322 may validate refined questions using pre-trained classifiers to ensure they meet specific criteria. These criteria may include relevance to the domain context, specificity, novelty, and logical consistency in both structure and semantics.

The output from the iterative refinement operation 322 may flow to an FMEA generation operation 324. This operation may be configured to generate an FMEA document based on the refined set of questions and answers. The FMEA generation operation 324 demonstrates the potential of the multi-agent framework to automate and enhance processes in industrial asset management and reliability engineering.

In some implementations, the FMEA generation operation 324 may leverage the domain-specific knowledge embedded within the AI agents to produce comprehensive failure analysis associated with physical assets corresponding to the industrial domain. This may include identifying potential failure modes, their effects, and possible mitigation strategies.

The multi-agent framework 304 and its associated operations may execute interactions in multiple iterative rounds. Each round may comprise steps such as routing questions to appropriate AI agents, generating responses, creating follow-up prompts, and applying filtering mechanisms. This iterative process may allow for continuous refinement and expansion of the generated content, adapting to the complexities and nuances of the industrial domain.

The example 300 may output a set of output data comprising at least one of the first set of domain-specific questions, a second set of questions generated through collaborative refinement, or a set of answers corresponding to these questions. This output may be used by downstream applications for various industrial purposes, such as predictive maintenance, anomaly detection, or reliability analysis.

In some implementations, the multi-agent framework 304 may be integrated with other components of a larger system, such as the domain context platform 112 described in connection with FIG. 1. This integration may facilitate the exchange of information between different parts of the system, potentially enhancing the overall capabilities for domain-specific data generation and analysis in industrial contexts.

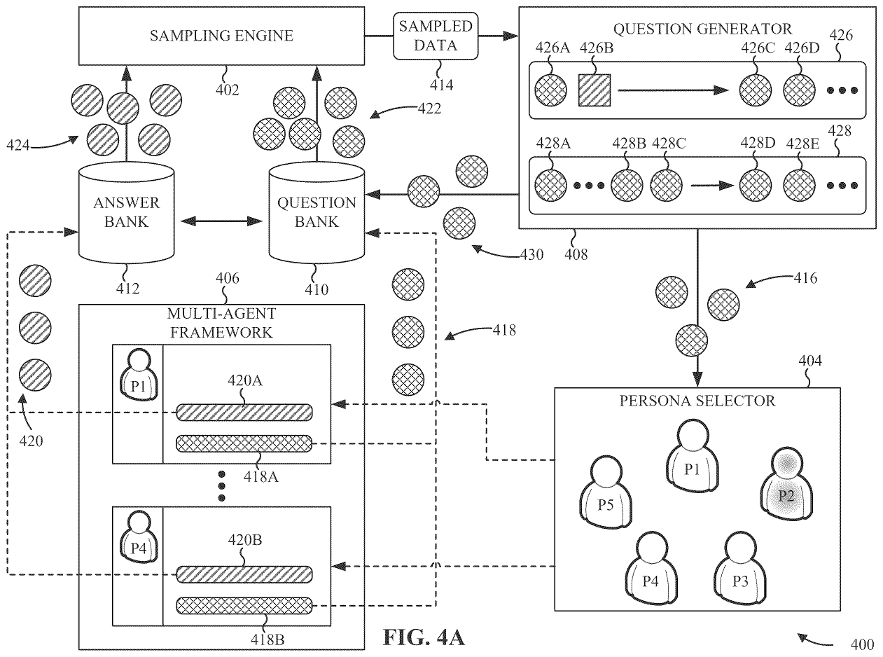

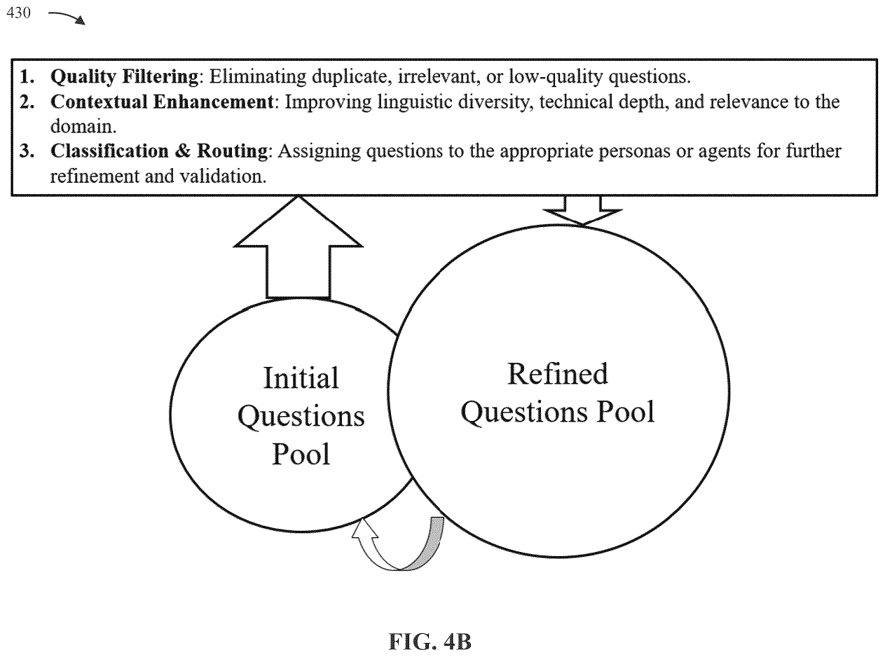

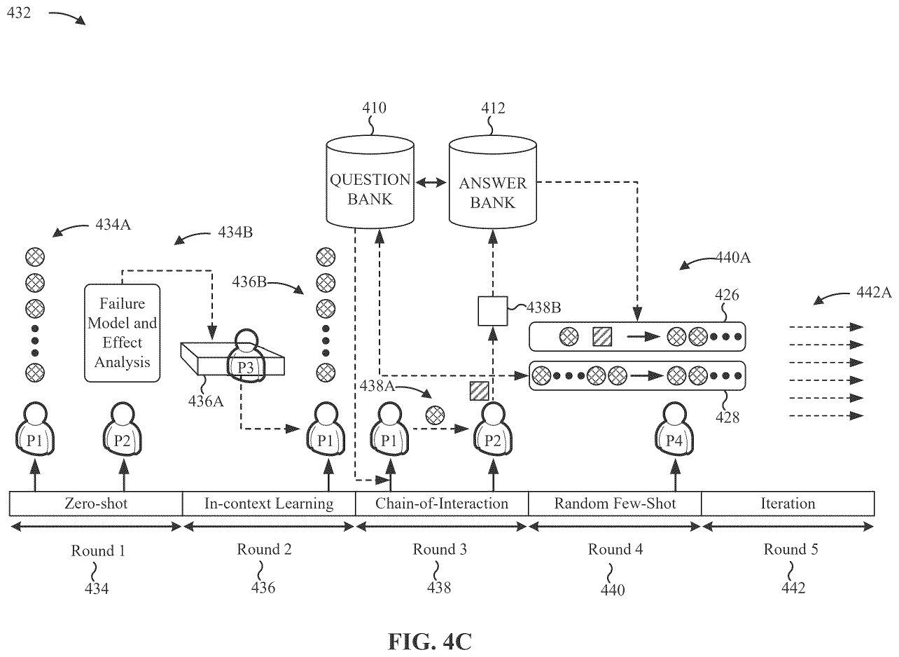

FIG. 4A illustrates a data flow diagram of an example 400 associated with implementing a multi-agent framework for domain-specific data generation. In some implementations, one or more aspects of example 400 may be performed by the domain context platform 112 described in connection with FIG. 1.

The example 400 includes a sampling engine 402 that may be configured to process and analyze input data received through a service interface, such as the service interface 114 described in connection with FIG. 1. The sampling engine 402 may extract relevant features, patterns, or metadata from the input data to inform the generation of domain-specific questions and prompts. In some implementations, the sampling engine 402 may utilize various data preprocessing techniques, such as normalization, feature extraction, or dimensionality reduction, to prepare the input data for use by other components of the system.

The sampling engine 402 interacts with a persona selector 404 and a multi-agent framework 406. The persona selector 404 may be configured to determine a set of AI agent personas based on the domain context. Each AI agent persona may be associated with a predefined role, such as a data scientist persona, an SME persona, a summarization persona, a question generation persona, or a question assignment persona. In some implementations, the persona selector 404 may analyze the content, complexity, or domain-specific terminology of each question to determine which persona is appropriate to process it.

The multi-agent framework 406 may be configured to initialize and manage a plurality of AI agents corresponding to the AI agent personas determined by the persona selector 404. The multi-agent framework 406 may facilitate collaborative interactions among the AI agents to refine and expand upon the initial set of domain-specific questions. In some implementations, the multi-agent framework 406 may be instantiated using a set of large language models, enabling sophisticated natural language processing and generation capabilities across different agent roles.

The sampling engine 402 generates sampled data 414 which is provided to a question generator 408. The question generator 408 may be configured to generate a first set of domain-specific questions based on the input data processed by the sampling engine 402. The question generator 408 may employ various prompt generation techniques, such as zero-shot reasoning, in-context learning, or chain-of-thought prompting, to create diverse and relevant questions tailored to the specific domain context.

The system includes a question bank 410 and an answer bank 412 that communicate bidirectionally with the multi-agent framework 406. The question bank 410 and answer bank 412 may serve as structured repositories for storing and refining domain-specific questions and answers. In some implementations, the question bank 410 and answer bank 412 may link generated answers to corresponding questions, facilitating efficient retrieval and utilization of domain knowledge.

Questions 416 flow from the question generator 408 to the persona selector 404. The persona selector 404 may assign each question to appropriate AI agent personas for processing based on role-specific classifiers or other criteria. This assignment process may facilitate the efficient distribution of questions to the most suitable AI agents for processing and refinement.

The multi-agent framework 406 includes multiple personas, such as P1 and P4, each associated with question generation operations 418A, 418B and answer generation operations 420A, 420B respectively. These operations may represent the collaborative process through which the AI agents refine and expand upon the initial set of domain-specific questions. In some implementations, the multi-agent framework 406 may use at least one response from a first AI agent to seed generation of a follow-up question by a second AI agent.

Questions 418 are processed through question generation operations 418A, 418B within the multi-agent framework 406. Similarly, answers 420 are generated through answer generation operations 420A, 420B. This iterative process of question generation and answering may allow for refinement and expansion of the generated content, adapting to the complexities and nuances of the industrial domain.

Additional questions 422 and answers 424 are exchanged between the components, representing the ongoing collaborative interactions among the AI agents within the multi-agent framework 406. This exchange of information may facilitate the generation of a second set of questions based on refinement of the first set of domain-specific questions and interactions among the plurality of AI agents.

The question generator 408 contains multiple question generation operations 426, 428. Operation 426 processes a prior question 426A and prior answer 426B to generate new questions 426C, 426D. Operation 428 processes prior questions 428A, 428B, 428C to generate new questions 428D, 428E. These operations demonstrate how the system may use previous questions and answers to generate new, contextually relevant questions, potentially improving the depth and breadth of the domain-specific knowledge exploration.

The persona selector 404 contains multiple persona representations labeled P1-P5, which may help direct questions to appropriate agents within the system. This dynamic routing of questions to specialized AI agents may enhance the efficiency and effectiveness of the question refinement process.

In some implementations, the system may evaluate the quality of at least one question using linguistic metrics or semantic metrics. This evaluation process may involve filtering, ranking, and refining questions to improve their relevance, specificity, and coherence within the domain context. The system may apply various techniques to ensure the quality of the generated questions, such as removing duplicate or irrelevant content based on semantic similarity or heuristic thresholds. For example, each generated question or answer may be evaluated for quality using a quality evaluation process, which may include linguistic or semantic metrics such as type-token ratio (TTR), Distinct-n, Self-BLEU, or perplexity. These metrics may be used to assess novelty, fluency, and coherence, and may inform decisions to filter or re-rank content.

The multi-agent framework 406 may execute interactions in multiple iterative rounds, each comprising steps such as routing questions to appropriate AI agents, generating responses, creating follow-up prompts, and applying filtering mechanisms. This iterative process may allow for continuous refinement and expansion of the generated content, adapting to the complexities and nuances of the industrial domain.

In some implementations, an AI agent within the multi-agent framework 406 may be configured to generate an FMEA document based on the generated questions and answers. This capability may demonstrate the potential of the system to automate and enhance processes in industrial asset management and reliability engineering.

The example 400 may output a set of output data comprising at least one of the first set of domain-specific questions, the second set of questions, or the set of answers for use by a downstream application. This output may serve as input for various industrial applications, such as predictive maintenance, anomaly detection, or reliability analysis. In some implementations, the system may store the set of answers in a structured repository linked to corresponding questions, facilitating efficient retrieval and utilization of the generated domain knowledge for future use or analysis.

FIG. 4B illustrates a diagram of an example 430 associated with refining questions in a multi-agent framework for domain-specific data generation. In some implementations, one or more aspects of example 430 may be performed by the domain context platform 112 described in connection with FIG. 1.

The example 430 includes an Initial Questions Pool and a Refined Questions Pool. These pools may be configured to store and manage sets of questions at different stages of the refinement process. The Initial Questions Pool may contain the first set of domain-specific questions generated based on the input data, while the Refined Questions Pool may store questions that have undergone quality improvement and contextual enhancement.

A number of processes in the question refinement workflow are shown to include: quality filtering, contextual enhancement, and classification and routing. The quality filtering process may be configured to eliminate duplicate, irrelevant, or low-quality questions from the initial set. The quality filtering process may utilize various techniques, such as semantic similarity analysis or heuristic thresholds, to identify and remove questions that do not meet predefined quality standards. The contextual enhancement process may be configured to improve the linguistic diversity, technical depth, and relevance of the questions to the domain. The contextual enhancement process may leverage domain-specific knowledge and natural language processing techniques to refine the phrasing and content of the questions, ensuring they are well-tailored to the industrial context. The classification and routing process may be configured to assign questions to the appropriate personas or agents for further refinement and validation. The classification and routing step may employ role-specific classifiers or other criteria to match the content and complexity of each question to the most suitable AI agent persona within the multi-agent framework.

The cyclical nature of the operations represent an iterative workflow. Questions in the Refined Questions Pool may be subject to further refinement or may serve as input for generating new questions, creating a feedback loop that may facilitate the continual improvement of the question set's quality and relevance to the domain context.

The example 430 may illustrate a systematic approach to ensuring the quality and relevance of domain-specific questions generated within the multi-agent framework. By incorporating quality filtering, contextual enhancement, and intelligent routing, the system may produce a refined set of questions that are well-suited for industrial applications such as predictive maintenance, anomaly detection, or reliability analysis.

FIG. 4C illustrates a diagram of an example 432 of a multi-round process for generating and refining questions through a collaborative AI framework. In some implementations, one or more aspects of example 432 may be performed by the domain context platform 112 described in connection with FIG. 1.

The process illustrated in FIG. 4C is divided into five sequential rounds (434-442), each representing a different phase of question development and refinement. This multi-round approach may facilitate the iterative improvement of domain-specific questions and answers, adapting to the complexities and nuances of the industrial domain.

Round 1 434 is labeled “Zero-shot” and shows two personas (P1, P2). In some implementations, these personas may correspond to AI agents initialized within the multi-agent framework, each configured to operate in accordance with a respective agent persona corresponding to a predefined role within a domain-specific task environment. The zero-shot approach may allow the system to generate initial questions without prior training on the specific domain context.

Round 1 434 includes an operation 434A, which may be configured to process input data and generate an initial set of domain-specific prompts. In some implementations, the input data may include metadata describing an asset operational history, a sensor log, or a diagnostic code related to the domain context. The zero-shot reasoning technique applied in this round may facilitate the generation of relevant questions even with limited initial context.

The persona P2 may perform a failure model and effect analysis operation 434B based on the initial set of domain-specific prompts generated by the persona P1. In this process, P2 may systematically analyze potential failure modes, their effects, and causes related to the industrial asset or system under consideration.

The FMEA process performed by P2 may involve several steps such as, for example, (1) an identification of potential failure modes, in which P2 may analyze the asset class to determine various ways in which the system or its components could potentially fail; (2) an assessment of failure effects, in which, for each identified failure mode, P2 may evaluate the potential consequences or impacts on the system's performance, safety, or reliability; (3) a determination of failure causes, in which P2 may investigate and document the potential root causes or mechanisms that could lead to each failure mode; (4) an evaluation of current controls, in which P2 may assess existing measures or controls in place to prevent or detect the occurrence of each failure mode; (5) a risk prioritization, in which P2 may assign severity, occurrence, and detection ratings to each failure mode, which may be used to calculate a Risk Priority Number (RPN) for prioritization purposes; (6) a recommendation of actions, in which, based on the analysis, P2 may suggest preventive or corrective actions to mitigate high-risk failure modes; or (7) a documentation process, in which P2 may compile the analysis results into a structured FMEA document, which may include detailed information about failure modes, effects, causes, current controls, and recommended actions. This operation may involve any number of other processes.

In some implementations, P2 may leverage domain-specific knowledge embedded within its AI model to enhance the accuracy and relevance of the FMEA process. The FMEA operation performed by P2 may provide valuable insights for improving asset reliability, optimizing maintenance strategies, and enhancing overall system performance in industrial contexts.

Round 2 436 is labeled “In-context Learning” and may include leveraging domain-specific knowledge to refine and expand upon the initial set of questions. The in-context learning technique may allow the AI agents to adapt their question generation based on the specific industrial context provided.

A persona P3 may generate, based on the FMEA, summary data 436A corresponding to answer data in the answer bank 412. Based on the summary data, P1 may generate refined questions in an operation 436B, which may be stored in the question bank 410.

Round 3 438 is labeled “Chain-of-Interaction” and includes collaborative interactions 438A between multiple personas (P1, P2, etc.). This round may facilitate collaborative generation of a second set of questions based on refinement of the first set of domain-specific questions and interactions among the plurality of AI agents.

The question bank 410 and answer bank 412 may serve as structured repositories for storing and refining domain-specific questions and answers. In some implementations, the system may store the set 438B of answers in a structured repository linked to corresponding questions, facilitating efficient retrieval and utilization of the generated domain knowledge.

The chain-of-interaction approach illustrated in Round 3 438 may involve using at least one response from a first AI agent to seed generation of a follow-up question by a second AI agent. This collaborative process may enhance the depth and breadth of the generated questions, leveraging the specialized knowledge of each AI agent persona.

Round 4 440 is labeled “Random Few-Shot” and may incorporate sampling techniques and question generation techniques at operation 440A to further refine and expand the question set. For example, operation 426 may involve processing a prior question and prior answer to generate new questions, while operation 428 may involve processing multiple prior questions to generate new questions. This approach may enhance the diversity and relevance of the generated questions.

Round 5 442 is labeled “Iteration” and may represent the system's ability to continually, periodically, or in response to a trigger event, refine and improve the generated questions and answers through multiple iterations 442A. The multi-round process illustrated in FIG. 4C may execute interactions in multiple iterative rounds, each including steps such as routing questions to appropriate AI agents, generating responses, creating follow-up prompts, and applying filtering mechanisms. This iterative approach may allow for continuous refinement and expansion of the generated content.

In some implementations, the quality of the generated questions may be evaluated using linguistic metrics or semantic metrics. This evaluation process may involve filtering, ranking, and refining questions to improve their relevance, specificity, and coherence within the domain context.

The multi-round process may incorporate mechanisms for improving the quality of the second set of questions. This may include filtering the second set of questions to remove content based on semantic similarity or heuristic thresholds, ranking the questions based on relevance or importance to the domain context, or refining the questions to improve linguistic clarity or coherence.

In some implementations, the system may validate the refined questions using pre-trained classifiers configured to assess whether each question satisfies a validation condition. A question may satisfy the validation condition by being relevant to the domain context, relevant to an intended use, specific, unambiguous, novel with respect to previously generated content, logically consistent in structure, or logically consistent in semantics.

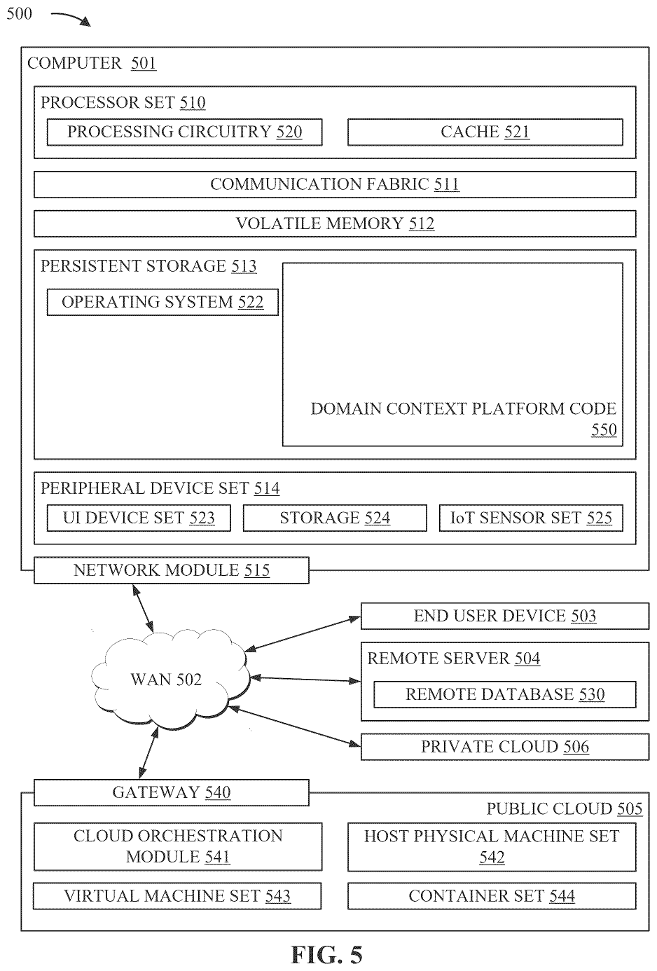

FIG. 5 is a diagram of an example computing environment 500 in which systems and/or methods described herein may be implemented. Various aspects of the present disclosure are described by narrative text, flowcharts, block diagrams of computer systems and/or block diagrams of the machine logic included in computer program product embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment is a term used in the present disclosure to describe any set of one, or more, storage media (also called “mediums”) collectively included in a set of one, or more, storage devices that collectively include machine readable code corresponding to instructions and/or data for performing computer operations specified in a given claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The computing environment 500 contains an example of an environment for the execution of at least some of the computer code involved in performing the inventive methods, such as domain context platform code, shown in block 550. In addition to block 550, the computing environment 500 includes, for example, a computer 501, a wide area network (WAN) 502, an end user device (EUD) 503, a remote server 504, a public cloud 505, and a private cloud 506. In this embodiment, the computer 501 includes a processor set 510 (including processing circuitry 520 and a cache 521), a communication fabric 511, a volatile memory 512, persistent storage 513 (including an operating system 522 and a block 550, as identified above), a peripheral device set 514 (including a user interface (UI) device set 523, storage 524, and an Internet of Things (IOT) sensor set 525), and a network module 515. The remote server 504 includes a remote database 530. The public cloud 505 includes a gateway 540, a cloud orchestration module 541, a host physical machine set 542, a virtual machine set 543, and a container set 544.

The computer 501 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as a remote database 530. As is well understood in the art of computer technology, and depending upon the technology, performance of a computer-implemented method may be distributed among multiple computers and/or between multiple locations. On the other hand, in this presentation of the computing environment 500, detailed discussion is focused on a single computer, specifically the computer 501, to keep the presentation as simple as possible. The computer 501 may be located in a cloud, even though it is not shown in a cloud in FIG. 5. On the other hand, the computer 501 is not required to be in a cloud except to any extent as may be affirmatively indicated.

The processor set 510 includes one or more computer processors of any type now known or to be developed in the future. The processing circuitry 520 may be distributed over multiple packages, for example, multiple, coordinated integrated circuit chips. The processing circuitry 520 may implement multiple processor threads and/or multiple processor cores. The cache 521 is memory that is located in the processor chip package(s) and is typically used for data or code that should be available for rapid access by the threads or cores running on the processor set 510. Cache memories are typically organized into multiple levels depending upon relative proximity to the processing circuitry. Alternatively, some, or all, of the cache for the processor set may be located “off chip.” In some computing environments, the processor set 510 may be designed for working with qubits and performing quantum computing.

Computer readable program instructions are typically loaded onto the computer 501 to cause a series of operational steps to be performed by the processor set 510 of the computer 501 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as the cache 521 and the other storage media discussed below. The program instructions, and associated data, are accessed by the processor set 510 to control and direct performance of the inventive methods. In the computing environment 500, at least some of the instructions for performing the inventive methods may be stored in the block 550 in persistent storage 513.

The communication fabric 511 is the signal conduction path that allows the various components of the computer 501 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

The volatile memory 512 is any type of volatile memory now known or to be developed in the future. Examples include dynamic type random access memory (RAM) or static type RAM. Typically, the volatile memory 512 is characterized by random access, but this is not required unless affirmatively indicated. In the computer 501, the volatile memory 512 is located in a single package and is internal to the computer 501, but, alternatively or additionally, the volatile memory 512 may be distributed over multiple packages and/or located externally with respect to the computer 501.

The persistent storage 513 is any form of non-volatile storage for computers that is now known or to be developed in the future. The non-volatility of this storage means that the stored data is maintained regardless of whether power is being supplied to the computer 501 and/or directly to the persistent storage 513. The persistent storage 513 may be a read only memory (ROM), but typically at least a portion of the persistent storage allows writing of data, deletion of data and re-writing of data. Some familiar forms of persistent storage include magnetic disks and solid state storage devices. The operating system 522 may take several forms, such as various known proprietary operating systems or open source Portable Operating System Interface-type operating systems that employ a kernel. The code included in block 550 typically includes at least some of the computer code involved in performing the inventive methods.

The peripheral device set 514 includes the set of peripheral devices of the computer 501. Data communication connections between the peripheral devices and the other components of the computer 501 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, the UI device set 523 may include components such as a display screen, speaker, microphone, wearable devices (such as goggles and smart watches), keyboard, mouse, printer, touchpad, game controllers, and haptic devices. The storage 524 is external storage, such as an external hard drive, or insertable storage, such as an SD card. The storage 524 may be persistent and/or volatile. In some embodiments, the storage 524 may take the form of a quantum computing storage device for storing data in the form of qubits. In embodiments where the computer 501 is required to have a large amount of storage (for example, where the computer 501 locally stores and manages a large database) then this storage may be provided by peripheral storage devices designed for storing very large amounts of data, such as a storage area network (SAN) that is shared by multiple, geographically distributed computers. The IoT sensor set 525 is made up of sensors that can be used in Internet of Things applications. For example, one sensor may be a thermometer and another sensor may be a motion detector.

The network module 515 is the collection of computer software, hardware, and firmware that allows the computer 501 to communicate with other computers through the WAN 502. The network module 515 may include hardware, such as modems or Wi-Fi signal transceivers, software for packetizing and/or de-packetizing data for communication network transmission, and/or web browser software for communicating data over the internet. In some embodiments, network control functions and network forwarding functions of the network module 515 are performed on the same physical hardware device. In other embodiments (for example, embodiments that utilize software-defined networking (SDN)), the control functions and the forwarding functions of the network module 515 are performed on physically separate devices, such that the control functions manage several different network hardware devices. Computer readable program instructions for performing the inventive methods can typically be downloaded to the computer 501 from an external computer or external storage device through a network adapter card or network interface included in the network module 515.

The WAN 502 is any wide area network (for example, the internet) capable of communicating computer data over non-local distances by any technology for communicating computer data, now known or to be developed in the future. In some embodiments, the WAN 502 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

The end user device (EUD) 503 is any computer system that is used and controlled by an end user (for example, a customer of an enterprise that operates the computer 501) and may take any of the forms discussed above in connection with the computer 501. The EUD 503 typically receives helpful and useful data from the operations of computer 501. For example, in a hypothetical case where the computer 501 is designed to provide a recommendation to an end user, this recommendation would typically be communicated from the network module 515 of the computer 501 through the WAN 502 to the EUD 503. In this way, the EUD 503 can display, or otherwise present, the recommendation to an end user. In some embodiments, the EUD 503 may be a client device, such as thin client, heavy client, mainframe computer, desktop computer and so on.

The remote server 504 is any computer system that serves at least some data and/or functionality to the computer 501. The remote server 504 may be controlled and used by the same entity that operates the computer 501. The remote server 504 represents the machine(s) that collect and store helpful and useful data for use by other computers, such as the computer 501. For example, in a hypothetical case where the computer 501 is designed and programmed to provide a recommendation based on historical data, then this historical data may be provided to the computer 501 from the remote database 530 of the remote server 504.

The public cloud 505 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of the public cloud 505 is performed by the computer hardware and/or software of the cloud orchestration module 541. The computing resources provided by the public cloud 505 are typically implemented by virtual computing environments that run on various computers making up the computers of the host physical machine set 542, which is the universe of physical computers in and/or available to the public cloud 505. The virtual computing environments (VCEs) typically take the form of virtual machines from the virtual machine set 543 and/or containers from the container set 544. It is understood that these VCEs may be stored as images and may be transferred among and between the various physical machine hosts, either as images or after instantiation of the VCE. The cloud orchestration module 541 manages the transfer and storage of images, deploys new instantiations of VCEs and manages active instantiations of VCE deployments. The gateway 540 is the collection of computer software, hardware, and firmware that allows the public cloud 505 to communicate through the WAN 502.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

The private cloud 506 is similar to the public cloud 505, except that the computing resources are only available for use by a single enterprise. While the private cloud 506 is depicted as being in communication with the WAN 502, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, the public cloud 505 and the private cloud 506 are both part of a larger hybrid cloud.

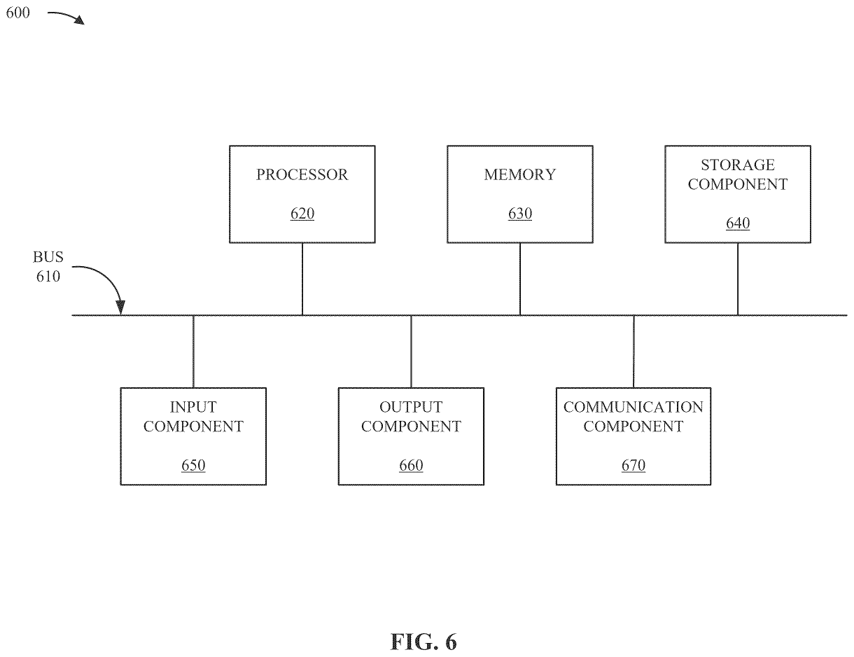

FIG. 6 is a diagram of example components of a device 600, which may implement one or more components of the computing environment 100. In some implementations, the device 600 may be, be similar to, include, or be included in the computer 501 shown in FIG. 5. The device 600 may be, be similar to, include, or be included in, an apparatus for performing one or more methods, processes, algorithms, operations, tasks, and/or techniques, as described herein. The device 600 may be, be similar to, include, or be included in, a computing device, a laptop, a workstation, a server device, or a personal computer, among other examples. As shown in FIG. 6, device 600 may include a bus 610 that interconnects various components or units, such as a processor 620, a memory 630, a storage component 640, an input component 650, an output component 660, and a communication component 670.

The processor 620 may be a central processing unit, such as a microprocessor, and may include single or multiple processors having single or multiple processing cores. The processor 620 may include another type of device, or multiple devices, configured for manipulating or processing information. For example, the processor 620 may include multiple processors interconnected in one or more manners, including hardwired or networked. The operations of the processor 620 may be distributed across multiple devices or units that can be coupled directly or across a local area or other suitable type of network. The processor 620 may include a cache, or cache memory, for local storage of operating data or instructions. The processor 620 is implemented in hardware, firmware, or a combination of hardware and software. In some implementations, the processor 620 includes one or more processors capable of being programmed to perform a function. In some implementations, the processor 620 may be, be similar to, include, or be included in processor set 510 shown in FIG. 5.

The memory 630 includes one or more memory components, which may each be volatile memory or non-volatile memory. The memory 630 may include non-transitory memory. The volatile memory can be random access memory (RAM) (e.g., a DRAM module, such as DDR SDRAM). The non-volatile memory of the memory 630 may be a disk drive, a solid state drive, flash memory, or phase-change memory. In some implementations, the memory 630 may be distributed across multiple devices. For example, the memory 630 may include network-based memory or memory in multiple clients or servers performing the operations of those multiple devices.

The memory 630 may include data for access by the processor 620. For example, the memory 630 may include executable instructions, application data, or an operating system, among other examples. The executable instructions may include one or more application programs, which may be loaded or copied, in whole or in part, from non-volatile memory to volatile memory to be executed by the processor 620. For example, the executable instructions may include instructions for performing techniques described in this disclosure. In some implementations, the application data may include functional programs, such as a computational programs, analytical programs, database programs, and so on. The operating system may be, for example, Microsoft Windows®, Mac OS X®, or Linux®; an operating system for a mobile device, such as a smartphone or tablet device; or an operating system for a non-mobile device, such as a mainframe computer.

The storage component 640 stores information and/or software related to the operation of the device 600. For example, the storage component 640 may include a hard disk drive, a magnetic disk drive, an optical disk drive, a solid state disk drive, a compact disc, a digital versatile disc, and/or another type of non-transitory computer-readable medium. The storage component 640 may be, be similar to, include, or be included in, the memory 630.

The input component 650 enables the device 600 to receive input, such as user input and/or sensed inputs. For example, the input component 650 may include a touch screen, a keyboard, a keypad, a mouse, a button, a microphone, a switch, a sensor, a global positioning system component, an accelerometer, a gyroscope, and/or an actuator. The output component 660 enables the device 600 to provide output, such as via a display, a speaker, and/or one or more light-emitting diodes. The communication component 670 enables the device 600 to communicate with other devices, such as via a wired connection and/or a wireless connection. For example, the communication component 670 may include a receiver, a transmitter, a transceiver, a modem, a network interface card, and/or an antenna.

The device 600 may perform one or more processes described herein. For example, a non-transitory computer-readable medium (e.g., the memory 630 and/or the storage component 640) may store a set of instructions (e.g., one or more instructions, code, software code, and/or program code) for execution by the processor 620. The processor 620 may execute the set of instructions to perform one or more processes described herein. In some implementations, execution of the set of instructions, by one or more processors 620, causes the one or more processors 620 and/or the device 600 to perform one or more processes described herein. In some implementations, hardwired circuitry may be used instead of or in combination with the instructions to perform one or more processes described herein. Thus, implementations described herein are not limited to any specific combination of hardware circuitry and software.

In the description herein, sentences describing a system, an apparatus, or a device as taking an action (such as performing, determining, initiating, receiving, calculating, deciding, computing, processing, etc.) are to be understood that some appropriate component of the system, apparatus, or device as taking the action. Such components may refer to hardware and/or software configured to take the action.

The terms “processor,” “processing circuitry,” “processor set,” or “controller” may refer to one or more processors. For example, reference to “a/the processor,” “a/the processor set,” or the like (in the singular) should be understood to refer to any one or more of the processors described in connection with FIGS. 5 and 6, such as a single processor or a combination of multiple different processors. Reference to “one or more processors” should be understood to refer to any one or more of the processors described in connection with FIGS. 5 and 6.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIGS. 5 and 6. For example, operation described as being performed by one or more memories can be performed by the same subset of the one or more memories or different subsets of the one or more memories. Additionally or alternatively, in some examples, one or more of the processors may be preconfigured to perform various functions or operations described herein without requiring configuration by software.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a processor is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods were described herein without reference to specific software code-it being understood that software and hardware can be designed to implement the systems and/or methods based, at least in part, on the description herein.

An “engine” refers to a component constructed, programmed, configured, or otherwise adapted to perform a specific function or set of functions. The term engine as used herein means a tangible device, component, or arrangement of components implemented using hardware, such as by an application specific integrated circuit (ASIC) or field-programmable gate array (FPGA), for example, or as a combination of hardware and software, such as by a processor-based computing platform and a set of program instructions that transform the computing platform into a special-purpose device to implement the particular functionality. An engine may also be implemented as a combination of the two, with certain functions facilitated by hardware alone, and other functions facilitated by a combination of hardware and software.

In an example, the software may reside in executable or non-executable form on a tangible machine-readable storage medium. Software residing in non-executable form may be compiled, interpreted, translated, or otherwise converted to an executable form prior to, or during, runtime. In an example, the software, when executed by the underlying hardware of the engine, causes the hardware to perform the specified operations. Accordingly, an engine is physically constructed, or specifically configured (e.g., hardwired), or temporarily configured (e.g., programmed) to operate in a specified manner or to perform part or all of any operations described herein in connection with that engine.

Considering examples in which engines are temporarily configured, each of the engines may be instantiated at different moments in time. For example, where the engines include a general-purpose hardware processor core configured using software, the general-purpose hardware processor core may be configured as respective different engines at different times. Software may accordingly configure a hardware processor core, for example, to constitute a particular engine at one instance of time and to constitute a different engine at a different instance of time.

In certain implementations, at least a portion, and in some cases, all, of an engine may be executed on the processor(s) of one or more computers that execute an operating system, system programs, and application programs, while also implementing the engine using multitasking, multithreading, distributed (e.g., cluster, peer-peer, cloud, etc.) processing where appropriate, or other such techniques. Accordingly, each engine may be realized in a variety of suitable configurations, and should generally not be limited to any particular implementation exemplified herein, unless such limitations are expressly called out. s used herein, the term “model” encompasses its plain and ordinary meaning. A model may include, among other things, one or more engines which receive an input and compute an output based on the input.

The number and arrangement of components shown in FIG. 6 are provided as an example. The device 600 may include additional components, fewer components, different components, or differently arranged components than those shown in FIG. 6. Additionally, or alternatively, a set of components (e.g., one or more components) of the device 600 may perform one or more functions described as being performed by another set of components of the device 600.

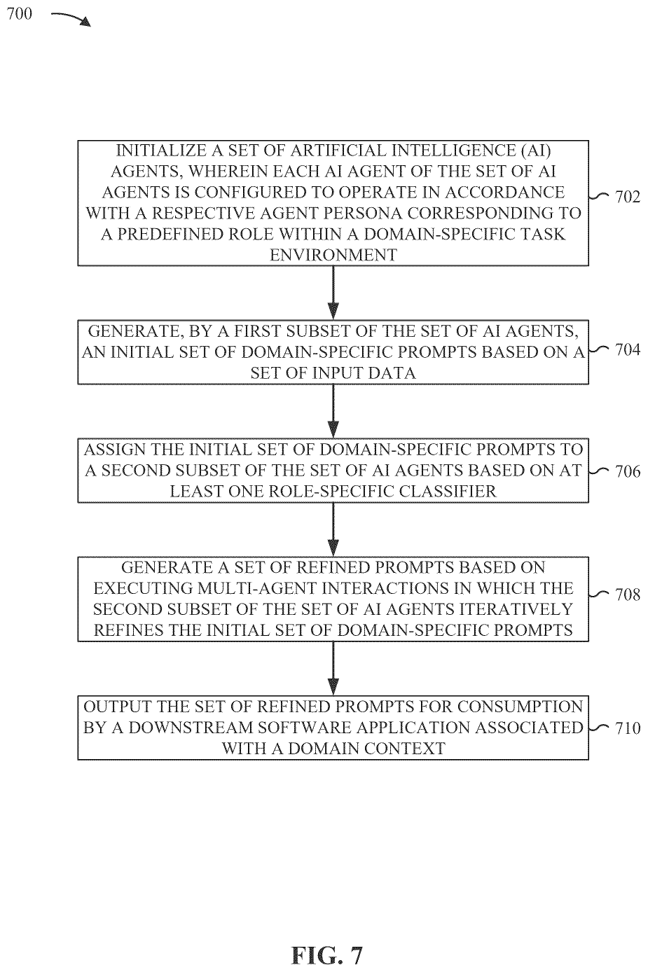

To further describe some implementations in greater detail, reference is next made to examples of techniques which may be performed by or using the multi-agent framework for domain-specific data generation as described herein. FIG. 7 is a flowchart of an example of a technique 700 associated with domain-specific data generation. The technique 700 can be executed using computing devices, such as the systems, hardware, and software described with respect to FIGS. 1-6. The technique 700 can be performed, for example, by executing a machine-readable program or other computer-executable instructions, such as routines, instructions, programs, or other code. The steps, or operations, of the technique 700, or another technique, method, process, or algorithm described in connection with the implementations disclosed herein can be implemented directly in hardware, firmware, software executed by hardware, circuitry, or a combination thereof.

For simplicity of explanation, the technique 700 is depicted and described herein as a series of steps or operations. However, the steps or operations of the technique 700 can occur in various orders and/or concurrently. Additionally, other steps or operations not presented and described herein may be used. Furthermore, not all illustrated steps or operations may be required to implement a technique in accordance with the disclosed subject matter.

At step 702, the technique 700 includes initializing a set of AI agents, wherein each AI agent of the set of AI agents is configured to operate in accordance with a respective agent persona corresponding to a predefined role within a domain-specific task environment. For example, the multi-agent framework 122 may initialize the set of AI agents. In some implementations, the predefined role may include at least one of a data scientist persona configured to generate model-related queries, an SME persona configured to provide domain-specific answers, a summarization persona configured to condense input context or responses, or a question assignment persona configured to direct queries to appropriate agent personas.

At step 704, the technique 700 includes generating, by a first subset of the set of AI agents, an initial set of domain-specific prompts based on a set of input data. For example, the question generator 118 may generate the initial set of domain-specific prompts. In some implementations, the input data may include at least one of metadata describing an asset operational history, a sensor log, or a diagnostic code related to the domain context.

At step 706, the technique 700 includes assigning the initial set of domain-specific prompts to a second subset of the set of AI agents based on at least one role-specific classifier. For example, the persona selector 120 may assign the initial set of domain-specific prompts to the second subset of the set of AI agents.

At step 708, the technique 700 includes generating a set of refined prompts based on executing multi-agent interactions in which the second subset of the set of AI agents iteratively refines the initial set of domain-specific prompts. For example, the multi-agent framework 122 may generate the set of refined prompts. In some implementations, executing the multi-agent interactions may include executing the multi-agent interactions in a plurality of iterative rounds, each round including: routing at least one question to an AI agent of the second subset of the set of AI agents; generating, by the AI agent, a response to the question; generating, by at least one of the AI agent or an additional AI agent of the second subset of the set of AI agents, at least one follow-up prompt based on the response; and applying a filtering step to remove redundant or low-quality prompts from the at least one follow-up prompt.

At step 710, the technique 700 includes outputting the set of refined prompts for consumption by a downstream software application associated with a domain context. For example, the domain context platform 112 may output the set of refined prompts.

In some implementations, generating the set of refined prompts may include: obtaining, by a first AI agent of the second subset of the set of AI agents, an answer associated with an initial prompt of the initial set of domain-specific prompts; extracting, by the first AI agent, context from the answer; and prompting, by the first AI agent, a second AI agent of the second subset of the set of AI agents to generate a new question based on the context.

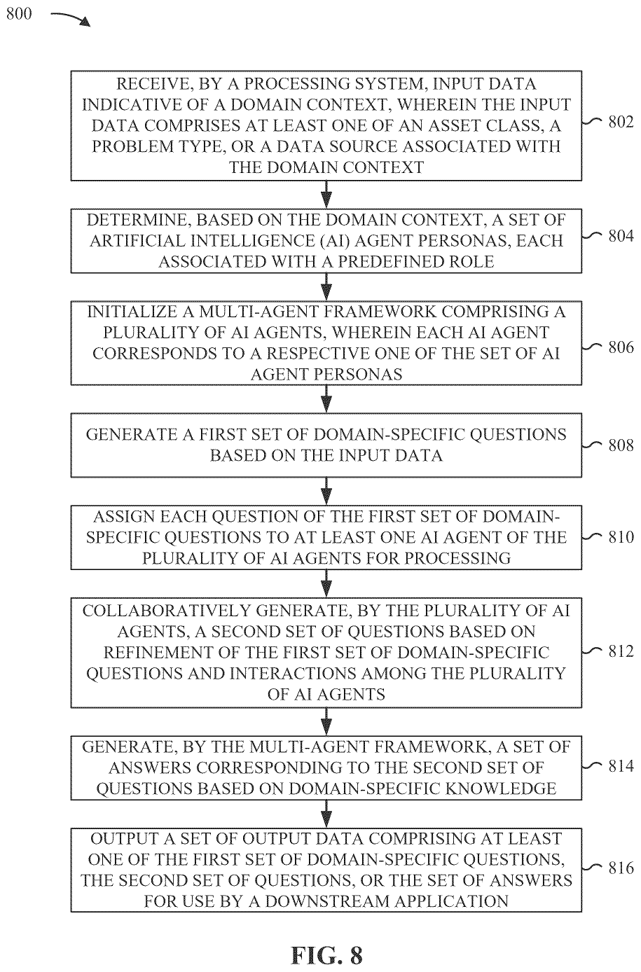

FIG. 8 is a flowchart of an example of a technique 800 associated with domain-specific data generation. The technique 800 can be executed using computing devices, such as the systems, hardware, and software described with respect to FIGS. 1-7. The technique 800 can be performed, for example, by executing a machine-readable program or other computer-executable instructions, such as routines, instructions, programs, or other code. The steps, or operations, of the technique 800, or another technique, method, process, or algorithm described in connection with the implementations disclosed herein can be implemented directly in hardware, firmware, software executed by hardware, circuitry, or a combination thereof.

For simplicity of explanation, the technique 800 is depicted and described herein as a series of steps or operations. However, the steps or operations of the technique 800 can occur in various orders and/or concurrently. Additionally, other steps or operations not presented and described herein may be used. Furthermore, not all illustrated steps or operations may be required to implement a technique in accordance with the disclosed subject matter.

At step 802, the technique 800 includes receiving, by a processing system, input data indicative of a domain context, wherein the input data includes at least one of an asset class, a problem type, or a data source associated with the domain context. For example, the domain context platform 112 may receive the input data. In some implementations, the input data may include metadata describing an asset operational history, a sensor log, or a diagnostic code related to the domain context.

At step 804, the technique 800 includes determining, based on the domain context, a set of AI agent personas, each associated with a predefined role. For example, the persona selector 120 may determine the set of AI agent personas. In some implementations, determining the set of AI agent personas may include selecting at least two personas from a set of personas, the set of personas including at least one of a data scientist persona, an SME persona, a summarization persona, a question generation persona, or a question assignment persona.

At step 806, the technique 800 includes initializing a multi-agent framework including a plurality of AI agents, wherein each AI agent corresponds to a respective one of the set of AI agent personas. For example, the multi-agent framework 122 may initialize the plurality of AI agents. In some implementations, the multi-agent framework may be instantiated using a set of large language models.

At step 808, the technique 800 includes generating a first set of domain-specific questions based on the input data. For example, the question generator 118 may generate the first set of domain-specific questions. In some implementations, generating the first set of domain-specific questions may include applying at least one prompt generation technique, the at least one prompt generation technique including at least one of a zero-shot reasoning technique, an in-context learning technique, or a chain-of-thought prompting technique.

At step 810, the technique 800 includes assigning each question of the first set of domain-specific questions to at least one AI agent of the plurality of AI agents for processing.

For example, the persona selector 120 may assign each question to the appropriate AI agent.

At step 812, the technique 800 includes collaboratively generating, by the plurality of AI agents, a second set of questions based on refinement of the first set of domain-specific questions and interactions among the plurality of AI agents. For example, the multi-agent framework 122 may facilitate the collaborative generation of the second set of questions. In some implementations, collaboratively generating the second set of questions may include using at least one response from a first AI agent of the plurality of AI agents to seed generation of a follow-up question by a second AI agent of the plurality of AI agents.

At step 814, the technique 800 includes generating, by the multi-agent framework, a set of answers corresponding to the second set of questions based on domain-specific knowledge. For example, the multi-agent framework 122 may generate the set of answers. In some implementations, the technique 800 may further include storing the set of answers in a structured repository linked to corresponding questions.

At step 816, the technique 800 includes outputting a set of output data including at least one of the first set of domain-specific questions, the second set of questions, or the set of answers for use by a downstream application. For example, the domain context platform 112 may output the set of output data. In some implementations, the domain context may correspond to an industrial domain, and the set of output data may include at least one of a failure analysis associated with a physical asset corresponding to the industrial domain, a maintenance prediction associated with the physical asset, or an anomaly detection associated with the physical asset.

In some implementations, the technique 800 may further include evaluating a quality of at least one question using at least one of a linguistic metric or a semantic metric. This evaluation may facilitate ensuring the quality of the generated questions.

In some implementations, the technique 800 may include generating, by an AI agent of the plurality of AI agents, an FMEA document based on at least one of the first set of domain-specific questions, the second set of questions, or the set of answers. This may demonstrate the potential of the system to automate and enhance processes in industrial asset management and reliability engineering.

In some implementations, ensuring quality of the second set of questions may include: filtering the second set of questions to remove content based on at least one of a semantic similarity or a heuristic threshold; ranking the second set of questions based on at least one of relevance to the domain context or importance to the domain context; generating a set of refined questions by refining the second set of questions to improve at least one of linguistic clarity or coherence; and validating the set of refined questions using one or more pre-trained classifiers configured to assess whether each question satisfies a validation condition. A question may satisfy the validation condition by being at least one of relevant to the domain context, relevant to an intended use, specific, unambiguous, novel with respect to previously generated content, logically consistent in structure, or logically consistent in semantics.

The technique 800 may facilitate the efficient generation and refinement of domain-specific questions and answers, leveraging the collaborative capabilities of multiple AI agents to produce high-quality, relevant output for various industrial applications.

According to an aspect of the implentations described herein, there is provided a computer-implemented method for domain-specific data generation. The method includes receiving input data indicative of a domain context, determining a set of AI agent personas based on the domain context, initializing a multi-agent framework comprising AI agents corresponding to the personas, generating a first set of domain-specific questions based on the input data, assigning each question to at least one AI agent for processing, collaboratively generating a second set of questions by the AI agents, generating a set of answers corresponding to the second set of questions, and outputting a set of output data for use by a downstream application. This method improves the efficiency and accuracy of domain-specific knowledge acquisition for industrial AI applications by simulating expert collaborations and leveraging specialized AI agents. Additionally, the method enhances the development of robust predictive maintenance strategies and improves operational efficiency in industrial settings through automated, context-aware question generation and refinement.

In embodiments, the set of AI agent personas can be determined by selecting at least two personas from a set including a data scientist persona, an SME persona, a summarization persona, a question generation persona, or a question assignment persona. This selection of specialized personas has the technical effect of tailoring the multi-agent framework to the specific requirements of the domain context. Additionally, it enables more effective collaboration and knowledge sharing among AI agents with diverse expertise.

In embodiments, generating the first set of domain-specific questions can involve applying at least one prompt generation technique, such as a zero-shot reasoning technique, an in-context learning technique, or a chain-of-thought prompting technique. These techniques have the technical effect of producing relevant and diverse questions even with limited initial context. Additionally, they enhance the system's ability to adapt to new domains or tasks with minimal additional training.

In embodiments, collaboratively generating the second set of questions can involve using at least one response from a first AI agent to seed generation of a follow-up question by a second AI agent. This iterative process has the technical effect of continuously refining and expanding the generated content, adapting to the complexities and nuances of the industrial domain. Additionally, it simulates real-world expert collaborations, leading to more comprehensive and insightful question sets.

In embodiments, the set of answers can be stored in a structured repository linked to corresponding questions. This structured storage has the technical effect of facilitating efficient retrieval and utilization of the generated domain knowledge for future use or analysis. Additionally, it enhances the system's ability to build upon previously generated knowledge, improving the overall efficiency of the knowledge acquisition process.

In embodiments, the quality of at least one question can be evaluated using linguistic or semantic metrics. This evaluation process has the technical effect of ensuring the relevance, coherence, and linguistic quality of the generated questions. Additionally, it enables continuous improvement of the AI agents' performance through feedback loops based on quality assessments.

In embodiments, an AI agent can generate an FMEA document based on the generated questions and answers. This capability has the technical effect of automating and enhancing processes in industrial asset management and reliability engineering. Additionally, it demonstrates the system's potential to produce specialized outputs for industrial applications, improving the efficiency of failure analysis and risk assessment processes.

In embodiments, the multi-agent framework can be instantiated using a set of large language models. This implementation has the technical effect of enabling sophisticated natural language processing and generation capabilities across different agent roles. Additionally, it allows for more nuanced and context-aware interactions between AI agents, enhancing the overall quality of the generated questions and answers.

In embodiments, ensuring quality of the second set of questions can involve filtering, ranking, refining, and validating the questions. Filtering can remove content based on semantic similarity or heuristic thresholds. Ranking can be based on relevance or importance to the domain context. Refining can improve linguistic clarity or coherence. Validating can use pre-trained classifiers to assess whether each question satisfies a validation condition. These quality assurance steps have the technical effect of producing a refined set of questions that are well-suited for industrial applications. Additionally, they enhance the overall reliability and usefulness of the generated content for downstream tasks.

In embodiments, a question can satisfy the validation condition by being relevant to the domain context, relevant to an intended use, specific, unambiguous, novel with respect to previously generated content, logically consistent in structure, or logically consistent in semantics. These validation criteria have the technical effect of ensuring that the generated questions meet high standards of quality and relevance. Additionally, they help prevent redundant or low-quality questions from being included in the final output.

In embodiments, the domain context can correspond to an industrial domain, and the set of output data can comprise a failure analysis, maintenance prediction, or anomaly detection associated with a physical asset. This domain-specific output has the technical effect of directly addressing critical needs in industrial asset management and predictive maintenance. Additionally, it demonstrates the system's ability to generate actionable insights that can improve operational efficiency and reduce downtime in industrial settings.

According to another aspect of the implentations described herein, there is provided a computer-implemented method for domain-specific prompt generation and refinement. The method includes initializing a set of AI agents with predefined roles, generating an initial set of domain-specific prompts, assigning the prompts to a subset of AI agents, generating refined prompts through multi-agent interactions, and outputting the refined prompts for use by a downstream application. This method improves the efficiency and quality of domain-specific prompt generation by leveraging specialized AI agents and iterative refinement processes. Additionally, it enhances the adaptability of the system to various domain contexts and task environments.

In embodiments, generating the set of refined prompts can involve obtaining an answer associated with an initial prompt, extracting context from the answer, and prompting another AI agent to generate a new question based on the context. This process has the technical effect of creating a dynamic, context-aware question generation system. Additionally, it enables the system to explore and expand upon relevant topics within the domain context more effectively.

In embodiments, the predefined roles can include a data scientist persona, an SME persona, a summarization persona, or a question assignment persona. These specialized roles have the technical effect of simulating real-world collaborative interactions between experts with diverse knowledge and skills. Additionally, they enable more targeted and relevant prompt generation and refinement based on specific domain requirements.

In embodiments, the input data can include metadata describing an asset operational history, a sensor log, or a diagnostic code related to the domain context. This diverse input data has the technical effect of providing rich contextual information for prompt generation. Additionally, it enables the system to generate more relevant and specific prompts tailored to the operational realities of industrial assets.

In embodiments, executing the multi-agent interactions can involve multiple iterative rounds, each including routing questions, generating responses, creating follow-up prompts, and applying filtering steps. This iterative process has the technical effect of continuously improving the quality and relevance of the generated prompts. Additionally, it allows the system to adapt to emerging insights and evolving domain knowledge throughout the prompt generation process.

According to another aspect of the implentations described herein, there is provided a computer program product comprising computer-readable storage media with program instructions for domain-specific prompt generation and refinement. The instructions cause a processor to perform operations including initializing AI agents, generating initial domain-specific prompts, assigning prompts to AI agents, generating refined prompts through multi-agent interactions, and outputting the refined prompts. This computer program product improves the efficiency and scalability of domain-specific knowledge acquisition by automating complex prompt generation and refinement processes. Additionally, it enables organizations to rapidly adapt to new asset classes, emerging failure modes, and evolving industrial landscapes.

According to another aspect of the implementations described herein, there is provided a computer system comprising a processor set, computer-readable storage media, and program instructions for domain-specific prompt generation and refinement. The system performs operations including initializing AI agents, generating initial domain-specific prompts, assigning prompts to AI agents, generating refined prompts through multi-agent interactions, and outputting the refined prompts. This computer system enhances the development of robust predictive maintenance strategies and improves operational efficiency in industrial settings through automated, context-aware prompt generation and refinement. Additionally, it facilitates more effective collaboration between data scientists and subject matter experts by simulating their interactions in a scalable, AI-driven framework.

In embodiments, assigning the initial set of domain-specific prompts to the subset of AI agents can be based on prompt features such as syntactic complexity, domain-specific terms, or topics. This feature-based assignment has the technical effect of ensuring that prompts are processed by the most suitable AI agents. Additionally, it improves the overall efficiency of the prompt refinement process by leveraging the specialized knowledge of each AI agent.

In embodiments, an AI agent can generate an FMEA document based on the initial or refined prompts. This capability has the technical effect of automating and enhancing critical processes in industrial asset management and reliability engineering. Additionally, it demonstrates the system's potential to produce specialized, high-value outputs for industrial applications, improving the efficiency of failure analysis and risk assessment processes.

This combination enhances the overall efficiency and adaptability of the domain-specific data generation process by leveraging a diverse set of specialized AI agent personas. The strategic selection of multiple personas enables more comprehensive and nuanced question generation, improving the quality and relevance of the generated content for industrial applications.

This combination improves the system's ability to generate relevant and diverse questions even with limited initial context. The use of advanced prompt generation techniques enables the system to adapt more effectively to new domains or tasks, enhancing its versatility and applicability across various industrial scenarios.

This combination synergistically enhances the system's capability to generate high-quality, domain-specific questions by leveraging both specialized AI agent personas and advanced prompt generation techniques. The diverse set of personas ensures comprehensive coverage of domain knowledge, while the sophisticated prompt generation techniques enable the system to produce relevant questions even in novel or complex industrial contexts.

This combination improves the overall quality and relevance of the generated questions by incorporating automated evaluation mechanisms. The use of linguistic and semantic metrics enables the system to assess and refine questions more effectively, leading to higher-quality outputs for industrial applications.

This combination enhances the practical utility of the system by enabling the automated generation of critical industrial documentation. The ability to produce FMEA documents directly from the generated questions and answers streamlines the process of failure analysis and risk assessment in industrial settings, improving efficiency and reliability.

This combination tailors the system specifically for industrial applications, enhancing its practical value in asset management and predictive maintenance. The ability to generate specialized outputs such as failure analyses, maintenance predictions, and anomaly detections directly addresses critical needs in industrial operations, improving asset reliability and operational efficiency.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A computer-implemented method, comprising:
receiving, by a processing system, input data indicative of a domain context, wherein the input data comprises at least one of an asset class, a problem type, or a data source associated with the domain context;
determining, based on the domain context, a set of artificial intelligence (AI) agent personas, each associated with a predefined role;
initializing a multi-agent framework comprising a plurality of AI agents, wherein each AI agent corresponds to a respective one of the set of AI agent personas;
generating a first set of domain-specific questions based on the input data;
assigning each question of the first set of domain-specific questions to at least one AI agent of the plurality of AI agents for processing;
collaboratively generating, by the plurality of AI agents, a second set of questions based on refinement of the first set of domain-specific questions and interactions among the plurality of AI agents, wherein collaboratively generating the second set of questions includes using at least one response from a first AI agent of the plurality of AI agents to seed generation of a follow-up question by a second AI agent, different from the first AI agent, of the plurality of AI agents;
generating, by the multi-agent framework, a set of answers corresponding to the second set of questions based on domain-specific knowledge; and
outputting a set of output data comprising at least one of the first set of domain-specific questions, the second set of questions, or the set of answers for use by a downstream application.

2. The computer-implemented method of claim 1, wherein determining the set of artificial intelligence (AI) agent personas comprises selecting at least two personas from a set of personas, the set of personas comprising at least one of a data scientist persona, a subject matter expert (SME) persona, a summarization persona, a question generation persona, or a question assignment persona.

3. The computer-implemented method of claim 1, wherein generating the first set of domain-specific questions comprises applying at least one prompt generation technique, the at least one prompt generation technique comprising at least one of a zero-shot reasoning technique, an in-context learning technique, or a chain-of-thought prompting technique.

4. (canceled)

5. The computer-implemented method of claim 1, further comprising storing the set of answers in a structured repository linked to corresponding questions.

6. The computer-implemented method of claim 1, further comprising evaluating a quality of at least one question using at least one of a linguistic metric or a semantic metric.

7. The computer-implemented method of claim 1, further comprising generating, by an AI agent of the plurality of AI agents, a failure modes and effects analysis (FMEA) document based on at least one of the first set of domain-specific questions, the second set of questions, or the set of answers.

8. The computer-implemented method of claim 1, wherein the multi-agent framework is instantiated using a set of large language models.

9. The computer-implemented method of claim 1, wherein ensuring quality of the second set of questions comprises:
filtering the second set of questions to remove content based on at least one of a semantic similarity or an heuristic threshold;
ranking the second set of questions based on at least one of relevance to the domain context or importance to the domain context;
generating a set of refined questions by refining the second set of questions to improve at least one of linguistic clarity or coherence; and
validating the set of refined questions using one or more pre-trained classifiers configured to assess whether each question satisfies a validation condition.

10. The computer-implemented method of claim 9, wherein a question satisfies the validation condition by being at least one of relevant to the domain context, relevant to an intended use, specific, unambiguous, novel with respect to previously generated content, logically consistent in structure, or logically consistent in semantics.

11. The computer-implemented method of claim 1, wherein the domain context corresponds to an industrial domain, and wherein the set of output data comprises at least one of a failure analysis associated with a physical asset corresponding to the industrial domain, a maintenance prediction associated with the physical asset, or an anomaly detection associated with the physical asset.

12. A computer program product, comprising:
one or more computer-readable storage media; and
program instructions stored on the one or more computer-readable storage media to perform operations, comprising:
initializing a set of artificial intelligence (AI) agents, wherein each AI agent of the set of AI agents is configured to operate in accordance with a respective agent persona corresponding to a predefined role within a domain-specific task environment;
generating, by a first subset of the set of AI agents, an initial set of domain-specific prompts based on a set of input data;
assigning the initial set of domain-specific prompts to a second subset of the set of AI agents based on at least one role-specific classifier;
generating a set of refined prompts based on executing multi-agent interactions in which the second subset of the set of AI agents iteratively refines the initial set of domain-specific prompts, wherein generating the set of refined prompts includes obtaining, by a first AI agent of the second subset of the set of AI agents, an answer associated with an initial prompt of the initial set of domain-specific prompts, extracting, by the first AI agent, context from the answer, and prompting, by the first AI agent, a second AI agent, different from the first AI agent, of the second subset of the set of AI agents to generate a new prompt based on the context; and
outputting the set of refined prompts for consumption by a downstream software application associated with a domain context.

13. (canceled)

14. The computer program product of claim 12, wherein the predefined role comprises least one of a data scientist persona configured to generate model-related queries, a subject matter expert (SME) persona configured to provide domain-specific answers, a summarization persona configured to condense input context or responses, or a question assignment persona configured to direct queries to appropriate agent personas.

15. The computer program product of claim 12, wherein the input data comprises at least one of metadata describing an asset operational history, a sensor log, or a diagnostic code related to the domain context.

16. The computer program product of claim 12, wherein executing the multi-agent interactions comprises executing the multi-agent interactions in a plurality of iterative rounds, each round comprising:
routing at least one question to an AI agent of the second subset of the set of AI agents;
generating, by the AI agent, a response to the question;
generating, by at least one of the AI agent or an additional AI agent of the second subset of the set of AI agents, at least one follow-up prompt based on the response; and
applying a filtering step to remove redundant or low-quality prompts from the at least one follow-up prompt.

17. A computer system, comprising:
a processor set;
one or more computer-readable storage media; and
program instructions stored on the one or more computer-readable storage media to cause the processor set to perform operations comprising:
initializing a set of artificial intelligence (AI) agents, wherein each AI agent of the set of AI agents is configured to operate in accordance with a respective agent persona corresponding to a predefined role within a domain-specific task environment;
generating, by a first subset of the set of AI agents, an initial set of domain-specific prompts based on a set of input data;
assigning the initial set of domain-specific prompts to a second subset of the set of AI agents based on at least one role-specific classifier;
generating a set of refined prompts based on executing multi-agent interactions in which the second subset of the set of AI agents iteratively refines the initial set of domain-specific prompts, wherein generating the set of refined prompts includes obtaining, by a first AI agent of the second subset of the set of AI agents, an answer associated with an initial prompt of the initial set of domain-specific prompts, extracting. by the first AI agent, context from the answer, and prompting, by the first AI agent, a second AI agent, different from the first AI agent, of the second subset of the set of AI agents to generate a new prompt based on the context; and
outputting the set of refined prompts for consumption by a downstream software application associated with a domain context.

18. The computer system of claim 17, wherein assigning the initial set of domain-specific prompts to the second subset of the set of AI agents is based on at least one prompt feature, the at least one prompt feature comprising at least one of a syntactic complexity, domain-specific term, or a topic.

19. The computer system of claim 17, wherein the predefined role comprises least one of a data scientist persona configured to generate model-related queries, a subject matter expert (SME) persona configured to provide domain-specific answers, a summarization persona configured to condense input context or responses, or a question assignment persona configured to direct queries to appropriate agent personas.

20. The computer system of claim 17, the operations further comprising generating, by an AI agent of the second subset of the set of AI agents, a failure modes and effects analysis (FMEA) document based on at least one of the initial set of domain-specific prompts or the set of refined prompts.

21. The computer-implemented method of claim 1, wherein collaboratively generating the second set of questions comprises executing multi-agent interactions in a plurality of iterative rounds, each round comprising:
routing at least one question to an AI agent of the plurality of AI agents;
generating, by the AI agent, a response to the question;
generating, by at least one of the AI agent or an additional AI agent of the plurality of AI agents, at least one follow-up question based on the response; and
applying a filtering step to remove redundant or low-quality questions from the at least one follow-up question.

22. The computer program product of claim 12, wherein the domain context corresponds to an industrial domain, and wherein the downstream software application is configured to generate, based on the set of refined prompts, at least one of a failure analysis associated with a physical asset corresponding to the industrial domain, a maintenance prediction associated with the physical asset, or an anomaly detection associated with the physical asset.
